(19) United States
(12) Patent Application Publication
(10) Pub. No.: US 2013/0114576 A1
(43) Pub. Date: May 9, 2013

(54) APPARATUS AND METHOD FOR PERFORMING UPLINK SYNCHRONIZATION IN MULTIPLE COMPONENT CARRIER SYSTEM

(71) Applicant: Pantech Co., Ltd., Seoul (KR)

(72) Inventors: Ki Bum KWON, Seoul (KR); Jae Hyun Ahn, Seoul (KR); Myung Cheul Jung, Seoul (KR)

(73) Assignee: Pantech Co., Ltd., Seoul (KR)

(21) Appl. No.: 13/667,717

(22) Filed: Nov. 2, 2012

(30) Foreign Application Priority Data
Nov. 3, 2011 (KR) 10-2011-0114158
Nov. 29, 2011 (KR) 10-2011-0125807

(51) Int. Cl. H04W 72/04

(52) U.S. Cl. 370/336

(57) ABSTRACT

The present invention relates to an apparatus and method for performing uplink synchronization n a multiple component carrier system. A method of User Equipment (UE) performing uplink synchronization in a multiple component carrier system includes receiving secondary serving configuration information on a cell used to configure one or more secondary serving cells in the UE from a Base Station (BS), receiving a Medium Access Control (MAC) message, including an activation indicator indicative of the activation or deactivation of the secondary serving cells configured in the UE and configuration information on a Timing Advance Group (TAG) that is a set of secondary serving cells having the same uplink time alignment value, from the BS, and setting the state of the secondary serving cells, configured in the UE, as activation or deactivation according to the activation indicator.

Priority to Korean patent application number 10-2011-0114158 filed on Nov. 3, 2011 and 10-2011-0125807 filed on Nov. 29, 2011, the entire disclosure of which is incorporated by reference herein, is claimed.

### BACKGROUND OF THE INVENTION

1. Field of the Invention

The present invention relates to wireless communication and, more particularly, to an apparatus and method for performing uplink synchronization n a multiple component carrier system.

2. Discussion of the Related Art

In a wireless communication environment, an electric wave propagated by a transmitter experiences propagation delay while it is transferred to a receiver. Accordingly, although both the transmitter and the receiver precisely know the time when the electric wave is propagated by the transmitter, the time when the signal arrives at the receiver is influenced by the distance between the transmitter and the receiver and surrounding propagation environments. If the receiver moves, the signal is changed over time. If the receiver does not precisely know the time when a signal transferred by the transmitter is received, the receiver receives a distorted signal although it does not receive the signal, thereby making communication impossible.

In a wireless communication system, synchronization between a base station and user equipment must be performed in advance in order to receive an information signal both in downlink/uplink. The type of synchronization is various, such as frame synchronization, information symbol synchronization, and sample period synchronization. Sample period synchronization must be obtained most basically in order to distinguish physical signals from each other.

User equipment obtains downlink synchronization based on the signal of a base station. A base station sends an agreed and specific signal so that user equipment can easily obtain downlink synchronization. The user equipment must be able to precisely determine the time when the specific signal has been transmitted by the base station. In downlink, a plurality of user equipments can obtain synchronization independently because one base station sends the same synchronization signal to the plurality of user equipments at the same time.

In uplink, a base station receives signals transmitted by a plurality of user equipments. If the distance between each of the user equipments and the base station is different, the signals received by the base station have different transmission delay times. If uplink information is transmitted based on obtained downlink synchronization, the base station receives pieces of information on the user equipments on different times. In this case, the base station cannot obtain synchronization based on any one user equipment. The same principle applies to a multiple component carrier system that supports a plurality of component carriers. A carrier aggregation is technology for efficiently using small and segmented bands. The carrier aggregation has an effect that a logically large band is used by physically binding a plurality of non-contiguous bands in the frequency domain.

Each of component carriers can have different delay time even under the same environment because the component carriers have different frequencies. Accordingly, a base station must perform uplink synchronization for each component carrier.

### SUMMARY OF THE INVENTION

An object of the present invention is to provide an apparatus and method for performing uplink synchronization in a multiple component carrier system.

Another object of the present invention is to provide an apparatus and method for transmitting a Medium Access Control (MAC) message, including an activation indicator indicative of the activation/deactivation of a serving cell and configuration information on a Timing Alignment Group (TAG).

Yet another object of the present invention is to provide an apparatus and method for transmitting a logical channel ID field to identify a MAC control element, including an activation indicator indicative of activation/deactivation and configuration information on a TAG.

Further yet another object of the present invention is to provide an apparatus and method for providing configuration information on a TAG, including only a secondary serving cell, through dedicated RRC signaling.

In an aspect of the present invention, a method of User Equipment (UE) performing uplink synchronization in a multiple component carrier system includes receiving secondary serving configuration information on a cell used to configure one or more secondary serving cells in the UE from a Base Station (BS), receiving a Medium Access Control (MAC) message, including an activation indicator indicative of the activation or deactivation of the secondary serving cells configured in the UE and configuration information on a Timing Advance Group (TAG) that is a set of secondary serving cells having the same uplink time alignment value, from the BS, and setting the state of the secondary serving cells, configured in the UE, as activation or deactivation according to the activation indicator.

In another aspect of the present invention, a method of UE performing uplink synchronization in a multiple component carrier system includes sending secondary serving cell configuration information, including information used to configure one or more secondary serving cells in UE, to the UE and sending a MAC message, including an activation indicator indicative of the activation or deactivation of the secondary serving cells configured in the UE and configuration information on a TAG that is a set of secondary serving cells having the same uplink time alignment value, to the UE.

In yet another aspect of the present invention, UE for performing uplink synchronization in a multiple component carrier system includes a UE receiver configured to receive secondary serving cell configuration information including information used to configure one or more secondary serving cells in the UE and a MAC message from a BS, a Radio Resource Control (RRC) message processing unit configured to configure the secondary serving cells in the UE based on the secondary serving cell configuration information and set the state of the secondary serving cells, configured in the UE, as activation or deactivation according to an activation indicator, a MAC message processing unit configured to obtain the activation indicator indicative of the activation or deactivation of the secondary serving cells configured in the UE and configuration information on a TAG that is a set of secondary serving cells having the same uplink time alignment value from the MAC message, and a UE transmission unit configured to send an RRC connection reconfiguration completion message to the BS in response to the reception of the secondary serving cell configuration information.

In further yet another aspect of the present invention, a BS for performing uplink synchronization in a multiple component carrier system includes a cell configuration unit configured to determine one or more secondary serving cells to be configured in UE and generate secondary serving cell configuration information used to configure the determined secondary serving cells in the UE, a TAG processing unit configured to generate a MAC message including an activation indicator indicative of the activation or deactivation of the secondary serving cells configured in the UE and configuration information on a TAG configured in a UE-specific manner, and a BS transmitter configured to send the MAC message to the UE.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

The accompany drawings, which are included to provide a further understanding of this document and are incorporated on and constitute a part of this specification illustrate embodiments of this document and together with the description serve to explain the principles of this document.

FIG. 1 shows a wireless communication system to which the present invention is applied;

FIG. 2 shows an example of a protocol structure for supporting multiple component carriers to which the present invention is applied;

FIG. 3 shows an example of a frame structure for a multiple component carrier operation to which the present invention is applied;

FIG. 4 shows linkage between downlink component carriers and uplink component carriers in a multiple component carrier system to which the present invention is applied;

FIG. 5 is a flowchart illustrating a method of performing uplink synchronization in accordance with an example of the present invention;

FIG. 6 shows the structure of a MAC message in accordance with an example of the present invention;

FIG. 7 is a block diagram showing the structure of a MAC control element in accordance with an example of the present invention;

FIG. 8 is a block diagram showing the structure of a MAC control element in accordance with another example of the present invention;

FIG. 9 is a block diagram showing the structure of a MAC control element in accordance with yet another example of the present invention;

FIG. 10 shows the structure of a MAC message in accordance with another example of the present invention;

FIG. 11 shows the structure of a MAC message in accordance with yet another example of the present invention;

FIG. 12 shows the structure of a MAC control element regarding activation and a TAG configuration in accordance with an example of the present invention;

FIG. 13 shows the structure of a MAC control element regarding a TAG configuration in accordance with an example of the present invention;

FIG. 14 shows the structure of a MAC control element regarding a TAG configuration in accordance with another example of the present invention;

FIG. 15 shows the structure of a MAC control element regarding a TAG configuration in accordance with yet another example of the present invention;

FIG. 16 shows the structure of a MAC control element regarding a TAG configuration in accordance with further yet another example of the present invention;

FIG. 17 is a flowchart illustrating a method of UE performing uplink synchronization in accordance with an example of the present invention;

FIG. 18 is a flowchart illustrating a method of a BS performing uplink synchronization in accordance with an example of the present invention;

FIG. 19A is a flowchart illustrating a method of transmitting an RRC message including information on a TAG in accordance with an embodiment of the present invention; and

FIG. 19B is a block diagram showing UE and a BS for performing a random access procedure in accordance with an example of the present invention.

### DETAILED DESCRIPTION OF THE EMBODIMENTS

Hereinafter, in this specification, the contents related to the present invention will be described in detail in connection with exemplary embodiments with reference to the accompanying drawings. It is to be noted that in assigning reference numerals to respective elements in the drawings, the same reference numerals designate the same elements throughout the drawings although the elements are shown in different drawings. Furthermore, in describing the embodiments of the present invention, a detailed description of the known functions and constructions will be omitted if it is deemed to make the gist of the present invention unnecessarily vague.

Furthermore, in this specification, a wireless communication network is described as a target, and tasks performed in the wireless communication network may be performed in a process in which a system (e.g., a base station) managing the wireless communication network controls the wireless communication network and sends data or may be performed in a terminal accessing the wireless communication network.

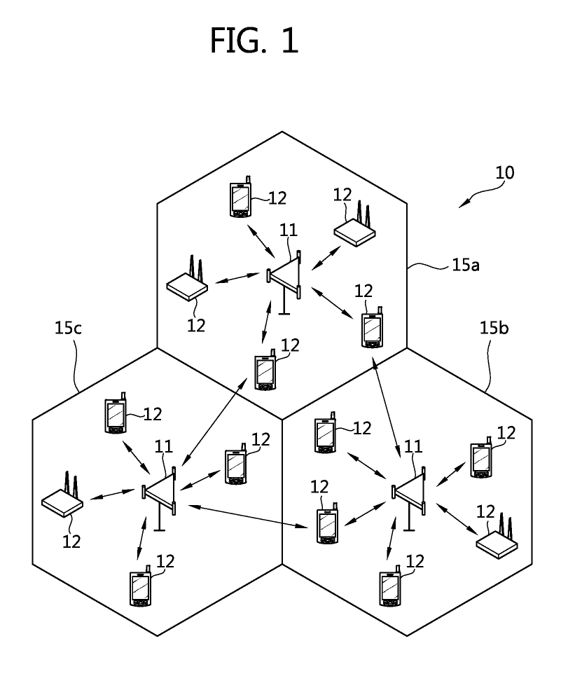

FIG. 1 shows a wireless communication system to which the present invention is applied.

Referring to FIG. 1, the wireless communication systems 10 are widely deployed in order to provide a variety of communication services, such as voice and packet data. The wireless communication system 10 includes one or more Base Stations (BS) 11. The BSs 11 provide communication services to specific cells 15a, 15b, and 15c. Each of the cells may be classified into a plurality of areas (called sectors).

User Equipment (UE) 12 may be fixed or mobile and also called another terminology, such as a Mobile Station (MS), a Mobile Terminal (MT), a User Terminal (UT), a Subscriber Station (SS), a wireless device, a Personal Digital Assistant (PDA), a wireless modem, or a handheld device. The BS 11 may also be called another terminology, such as an evolved NodeB (eNB), a Base Transceiver System (BTS), an access point, a femto BS, a home nodeB, or a relay. The cell should be interpreted as a comprehensive meaning that indicates some area covered by the BS 11. The cell has a meaning to cover various coverage areas, such as a mega cell, a macro cell, a micro cell, a pico cell, and a femto cell.

Hereinafter, downlink refers to communication from the BS 11 to the UE 12, and uplink refers to communication from the UE 12 to the BS 11. In downlink, a transmitter may be part of the BS 11, and a receiver may be part of the UE 12. In uplink, a transmitter may be part of the UE 12, and a receiver may be part of the BS 11. Multiple access schemes applied to the wireless communication system are not limited. A variety of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier-Frequency Division Multiple Access (SC-FDMA), OFDM-FDMA, OFDM-TDMA, and OFDM-CDMA, may be used. Uplink transmission and downlink transmission may be performed in accordance with a Time Division Duplex (TDD) scheme using different times or a Frequency Division Duplex (FDD) scheme using different frequencies.

A Carrier Aggregation (CA) is also called a spectrum aggregation or a bandwidth aggregation. An individual unit carrier aggregated by a carrier aggregation is called a Component Carrier (CC). Each of the CCs is defined by the bandwidth and the center frequency. The carrier aggregation is introduced to support an increased throughput, prevent an increase of costs due to the introduction of wideband Radio Frequency (RF) devices, and guarantee compatibility with the existing system. For example, if five CCs are allocated as the granularity of a carrier unit having a 20 MHz bandwidth, a maximum bandwidth of 10 MHz can be supported.

A carrier aggregation may be divided into a contiguous carrier aggregation that is performed between contiguous component carriers and a non-contiguous carrier aggregation that is performed between non-contiguous component carriers in the frequency domain. The number of aggregated carriers may be differently set in downlink and uplink. A case where the number of downlink component carriers is equal to the number of uplink component carriers is called a symmetric aggregation, and a case where the number of downlink component carriers is different from the number of uplink component carriers is called an asymmetric aggregation.

Component carriers may have different sizes (i.e., bandwidths). For example, assuming that 5 component carriers are used to form a 70 MHz band, a resulting configuration may be, for example, a 5 MHz component carrier (carrier #0)+a 20 MHz component carrier (carrier #1)+a 20 MHz component carrier (carrier #2)+a 20 MHz component carrier (carrier #3)+a 5 MHz component carrier (carrier #4).

Hereinafter, a multiple component carrier system refers to a system that supports a carrier aggregation. In a multiple component carrier system, a contiguous carrier aggregation and/or a non-contiguous carrier aggregation may be used, and a symmetric aggregation or an asymmetric aggregation may be used.

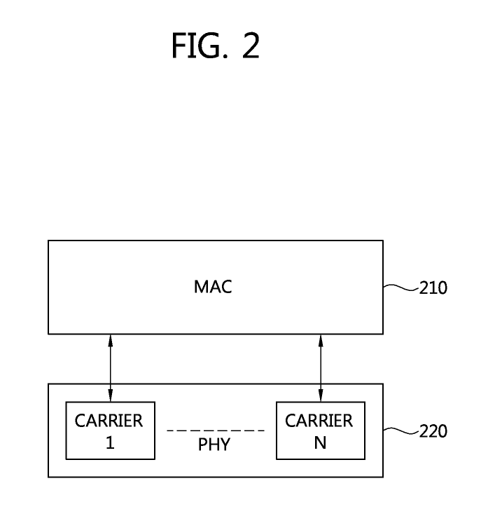

FIG. 2 shows an example of a protocol structure for supporting multiple component carriers to which the present invention is applied.

Referring to FIG. 2, a common Medium Access Control (MAC) entity 210 manages a physical layer 220 using a plurality of carriers. A MAC management message that is transmitted through a specific carrier may also be applied to other carriers. That is, the MAC management message can control other carriers including the specific carrier. The physical layer 220 may operate in accordance with a Time Division Duplex (TDD) method and/or a Frequency Division Duplex (FDD) method.

Several physical control channels are used in the physical layer 220. A physical downlink control channel (PDCCH) informs UE of the resource allocation of a paging channel (PCH) and a downlink shared channel (DL-SCH) and Hybrid Automatic Repeat Request (HARQ) information related to a DL-SCH. A PDCCH can carry an uplink grant that informs UE of the allocation of resources for uplink transmission. A physical control format indicator channel (PCFICH) is used to inform UE of the number of OFDM symbols used in PDCCHs and is transmitted every subframe. A physical hybrid ARQ indicator channel (PHICH) carries HARQ ACK/NAK signals in response to uplink transmission. A physical uplink control channel (PUCCH) carries HARQ ACK/NAK for downlink transmission, a scheduling request, and uplink control information, such as a Channel Quality Indicator (CQI). A physical uplink shared channel (PUSCH) carries an uplink-shared channel (UL-SCH). A physical random access channel (PRACH) carries a random access preamble.

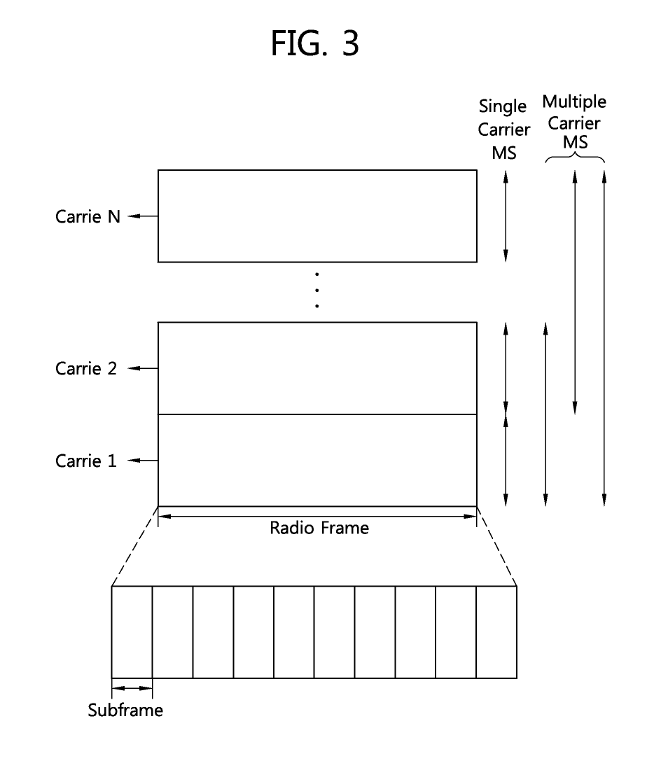

FIG. 3 shows an example of a frame structure for a multiple component carrier operation to which the present invention is applied.

Referring to FIG. 3, a frame includes 10 subframes. The subframe includes a plurality of OFDM symbols. Each carrier may have its own control channel (e.g., a PDCCH). Multiple component carriers may be contiguous to each other or may not be contiguous to each other. UE can support one or more carriers depending on the capabilities of the UE.

A component carrier may be divided into a Primary Component Carrier (PCC) and a Secondary Component Carrier (SCC) depending on whether it has been activated or not. The PCC is always activated, and the SCC is activated or deactivated depending on a specific condition. The term ‘activation’ refers to a state in which the transmission or reception of traffic data is being performed or a state in which the transmission or reception of traffic data is in a ready state. The term ‘deactivation’ refers to a state in which the transmission or reception of traffic data is impossible, but measurement or the transmission/reception of minimum information is possible. UE may use only one PCC or may use one or more SCCs along with a PCC. A BS may allocate a PCC and/or an SCC to UE.

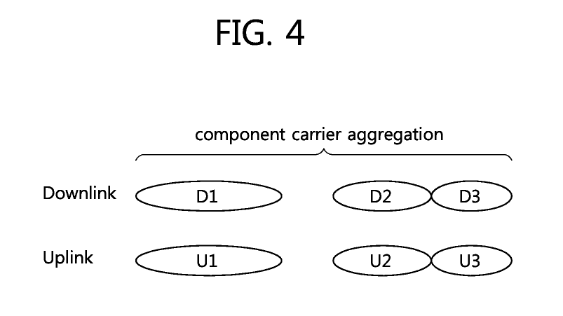

FIG. 4 shows linkage between downlink component carriers and uplink component carriers in a multiple component carrier system to which the present invention is applied.

Referring to FIG. 4, for example, downlink component carriers D1, D2, and D3 are aggregated. In uplink, uplink component carriers U1, U2, and U3 are aggregated. Here, Di is the index of the downlink component carrier, and Ui is the index of the uplink component carrier (i=1, 2, 3). Each of the indices is not identical with sequence of a component carrier or the position of the frequency band of a corresponding component carrier.

Meanwhile, at least one downlink component carrier is a PCC, and the remaining component carriers may be configured as SCCs. Likewise, at least one uplink component carrier is a PCC, and the remaining component carriers may be configured as SCCs. For example, D1 and U1 are PCCs, and D2, U2, D3, and U3 are SCC.

Here, the index of the primary component carrier may be set to 0, and one of other natural numbers may be the index of the secondary component carrier. For example, the index of the downlink/uplink component carrier may be set to have the same index of a component carrier (or a serving cell) including a corresponding downlink/uplink component carrier. For another example, only the component carrier index or the secondary component index is set, and there may be no uplink/uplink component carrier index in a corresponding component carrier. The component carrier index may be represented by a serving cell index and may be divided into a serving cell index including a primary serving cell and a secondary serving cell index including only secondary serving cells.

In an FDD system, a downlink component carrier and an uplink component carrier may be linked to each other in a one-to-one manner. For example, D1 may be linked to U1, D2 may be linked to U2, and D3 may be linked to U3 in a one-to-one manner. UE establishes linkage between the downlink component carriers and the uplink component carriers through system information transmitted by a logical channel BCCH or a UE-dedicated RRC message transmitted by a DCCH. This link is called System Information Block 1 (SIB1) link or SIB2 link. Each link may be set up in a cell-specific manner or a UE-specific manner. For example, the PCC may be configured in a cell-specific way, and the SCC may be configured in a UE-specific way.

Here, the downlink component carrier and the uplink component carrier may have a link configuration 1:n or n:1 in addition to the 1:1 link configuration.

A primary serving cell means one serving cell that provides security input and NAS mobility information in an RRC establishment or re-establishment state. At least one cell may be configured to form a set of serving cells along with a primary serving cell depending on the capabilities of UE. The at least one cell is called a secondary serving cell.

Accordingly, a set of serving cells configured for one UE may include only one primary serving cell or one primary serving cell and at least one secondary serving cell.

A downlink component carrier corresponding to a primary serving cell is called a downlink PCC (DL PCC), and an uplink component carrier corresponding to a primary serving cell is called an uplink PCC (UL PCC). Furthermore, in downlink, a component carrier corresponding to a secondary serving cell is called a downlink SCC (DL SCC) and in uplink, a component carrier corresponding to a secondary serving cell is called an uplink SCC (UL SCC). Only one downlink component carrier may correspond to one serving cell, and both a downlink component carrier and an uplink component carrier may correspond to one serving cell.

Accordingly, a concept that communication between UE and a BS is performed through a DL CC or a UL CC in a carrier system is the same as a concept that communication between UE and a BS is performed through a serving cell. For example, in a method of performing random access according to the present invention, a concept that UE sends a preamble using a UL CC can be considered as the same concept that UE sends a preamble using a primary serving cell or a secondary serving cell. Furthermore, a concept that UE receives downlink information using a DL CC can be considered as the same concept that US receives downlink information using a primary serving cell or a secondary serving cell.

Meanwhile, a primary serving cell and a secondary serving cell have the following characteristics.

First, a primary serving cell is used to send a PUCCH. In contrast, a secondary serving cell is unable to send a PUCCH, but can send some of pieces of control information within a PUCCH through a PUSCH.

Second, a primary serving cell is always activated, whereas a secondary serving cell is activated or deactivated depending on a specific condition. The specific condition may correspond to a case where a BS has received an activation or deactivation MAC control element message or a deactivation timer configured in each secondary serving cell within UE has expired.

Third, when a primary serving cell experiences a Radio Link Failure (RLF), RRC re-establishment is triggered, or a secondary serving cell experiences an RLF, RRC re-establishment is not triggered. Or, an RLF is not defined for a secondary serving cell. An RLF occurs when downlink performance maintains a threshold or lower for a specific time or when a random access procedure through a primary serving cell has failed by a threshold or higher. If a random access procedure through a primary serving cell has failed by a threshold or higher, only the corresponding random access procedure is terminated.

Fourth, a primary serving cell may be changed by a change of a security key or by a handover procedure accompanied by a random access procedure. In the case of a Contention Resolution (CR) message, only a Physical Downlink Control CHannel (PDCCH) indicating a CR has to be changed through a primary serving cell, and information on the CR can be changed through a primary serving cell or a secondary serving cell.

Fifth, information on a Non-Access Stratum (NAS) is received through a primary serving cell.

Sixth, a primary serving cell always includes a pair of a DL PCC and a UL PCC.

Seventh, a different CC for each UE can be configured as a primary serving cell.

Eighth, procedures, such as the reconfiguration, addition, and removal of a secondary serving cell, can be performed by a Radio Resource Control (RRC) layer. In adding a new secondary serving cell, RRC signaling can be used to send system information on a dedicated secondary serving cell.

Ninth, a primary serving cell can provide a PDCCH (e.g., downlink allocation information or information on an uplink grant) allocated to a UE-specific search space configured to send control information to only specific UE within a region where the control information is transmitted and a PDCCH (e.g., system information (SI), a Random Access Response (RAR), and Transmit Power Control (TPC)) allocated to a common search space configured to send control information to all UEs within a cell or a plurality of UEs that comply with a specific condition within a cell. In contrast, only a UE-specific search space can be configured in a secondary serving cell. That is, UE is unable to receive pieces of control information, transmitted through a common search space, and pieces of data information indicated by the pieces of control information because the UE cannot check the common search space through a secondary serving cell.

The technical spirit of the present invention regarding the characteristics of a primary serving cell and a secondary serving cell are not necessarily limited to the above description, but may include a large number of examples.

In a wireless communication system, synchronization between a BS and UE must be first performed in order to receive an information signal both in downlink and uplink. In the case of uplink, a BS receives signals transmitted by a plurality of UEs. If the distance between each UE and the BS is different, each of the signals received by the BS has different transmission delay time. If each UE sends uplink information based on obtained downlink synchronization, the BS receives the pieces of information of the UEs at different times. In this case, the BS cannot obtain synchronization based on any one UE. Accordingly, a procedure of obtaining uplink synchronization which is different from a procedure of obtaining downlink synchronization is necessary.

For example, a random access procedure may be performed in order to obtain uplink synchronization. The random access procedure may be divided into a contention-based random access procedure and a non-contention-based random access procedure. The greatest difference between the contention-based random access procedure and the non-contention-based random access procedure is whether a random access preamble is dedicated and designated to only UE or not. In the non-contention-based random access procedure, there is contention (or a collision) with another UE because specific UE uses a dedicated random access preamble designated thereto. The term ‘contention’ means that a BS configures time/frequency/sequence resources, configured so that UE can access the BS, so that a plurality of UEs can use the time/frequency/sequence resources without allocating the resources to each UE and two or more UEs use the resources contentionally.

In the contention-based random access procedure, there is a possibility of contention with another UE other than specific UE because the specific UE uses randomly selected time/frequency resources and a random access preamble. Time/frequency resources through which a random access preamble is transmitted from UE to a BS include a PRACH. That is, the random access preamble is transmitted from the UE to the BS through the PRACH. In the contention-based random access procedure, what UE randomly sends a random access preamble to a BS through a PRACH may be called PRACH transmission according to the choice of the UE. In the non-contention-based random access procedure, what UE receives a PDCCH order, indicating the start of a random access procedure, from a BS through a PDCCH and the UE sends a dedicated random access preamble to the BS through a PRACH may be called PRACH transmission according to the order of the BS.

During a random access procedure, UE obtains uplink synchronization by adjusting an uplink time based on a value or a timing alignment value within a timing advance command field included in a random access response provided by a BS. The timing alignment value is information, indicating the time that has to be adjusted in order to set uplink synchronization in a specific secondary serving cell in quality. A criterion for determining the time that has to be adjusted is a point of time at which downlink synchronization is performed by a timing reference cell in the random access procedure of corresponding UE. The timing alignment value may also be called a timing advance value.

If a specific time elapses after uplink synchronization is set based on a timing alignment value, the uplink synchronization may not be valid due to a change of an external radio channel, such as the movement of UE. Accordingly, a Time Alignment Timer (TAT) which can be configured by a BS in order for the BS to determine whether obtained uplink synchronization is valid or not and that enables UE to start a random access procedure so that the UE can obtain uplink synchronization after the TAT expires is configured in the UE. If a TAT operates, UE and a BS determine that uplink synchronization has been performed between them. If a TAT expires or does not operate, UE and a BS determine that synchronization has not been performed between them, and thus the UE does not perform the entire uplink transmission other than the transmission of a random access preamble.

In a multiple component carrier system, one UE performs communication with a BS through a plurality of component carriers or a plurality of serving cells. If all signals transmitted from UE to a BS through a plurality of serving cells have the same time delay, the UE can obtain uplink synchronization for all the serving cells based on one timing alignment value. In contrast, if signals transmitted to a BS through a plurality of serving cells have different time delays, a different timing alignment value is necessary for each serving cell. A plurality of timing alignment values for a plurality of serving cells is called multiple timing alignment values. The multiple timing alignment values may also be called multiple timing advance values. And the timing alignment value may also be called timing advance value.

If UE performs random access procedures for serving cells one by one in order to obtain multiple timing alignment values, there occurs overhead for limited uplink and downlink resources because the number of random access procedures necessary to obtain uplink synchronization is increased. Furthermore, the complexity of a synchronization tracking procedure for maintaining the uplink synchronization may be increased. In order to reduce the overhead and complexity, a Timing Alignment Group (TAG) is defined. The TAG may also be called a timing advance group.

A TAG refers to a group, including serving cell(s) which use the same timing alignment value and the same timing reference or a timing reference cell including the timing reference, from among serving cells in which UL CCs have been configured. Here, the timing reference is a DL CC, that is, a reference for calculating a timing alignment value. For example, if a first serving cell and a second serving cell belong to a TAG1 and the second serving cell is a timing reference cell, the same timing alignment value TA1 is applied to the first serving cell and the second serving cell, and the first serving cell applies the timing alignment value TA1 based on a point of time at which the downlink synchronization of a DL CC is performed by the second serving cell. In contrast, if a first serving cell and a second serving cell belong to a TAG1 and a TAG2, respectively, the first serving cell and the second serving cell become respective timing reference cells within corresponding TAGs and different timing alignment values TA1 and TA2 are applied to the first serving cell and the second serving cell.

A TAG may include a primary serving cell, may include one or more secondary serving cells, and may include a primary serving cell and one or more secondary serving cells. Each TAG includes one or more serving cells in which an UL CC has been configured, and information on a serving cell mapped to each TAG is called TAG configuration information. If a serving BS first configures a TAG or determines to reconfigure a TAG, the BS sends the configuration or re-configuration of the TAG to UE through RRC signaling.

A primary serving cell does not change a TAG. Furthermore, if multiple timing alignment values are necessary, UE has to be able to support two or more TAGs. For example, the UE has to be able to support TAGs that are divided into a primary TAG (pTAG) including a primary serving cell and a secondary TAG (sTAG) not including a primary serving cell. Here, only one pTAG may always exist, and one or more sTAGs may exist if multiple timing advance values are necessary. That is, if multiple timing alignment values are necessary, a plurality of TAGs may be configured.

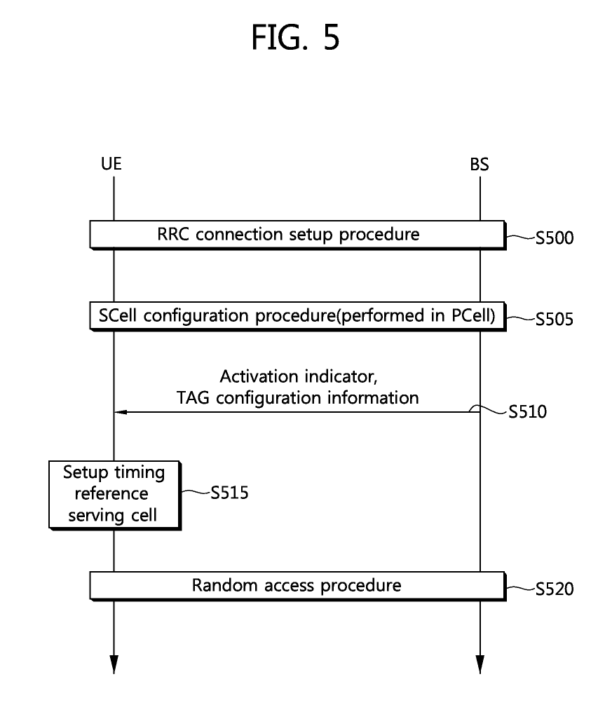

FIG. 5 is a flowchart illustrating a method of performing uplink synchronization in accordance with an example of the present invention.

Referring to FIG. 5, UE performs an RRC connection establishment procedure with a BS at step S500. The RRC connection establishment procedure includes UE sending an RRC connection request message to a BS, the BS sending an RRC connection setup message to the UE, and the UE sending an RRC connection setup-complete message to the BS. An object of the RRC connection establishment procedure is to switch UE to RRC-connected mode. The RRC connection establishment includes the configuration of a Signaling Radio Bearer (SRB) 1.

The BS performs a secondary serving cell configuration procedure for configuring one or more secondary serving cells in the UE at step S505. The secondary serving cell configuration procedure can be performed through an RRC connection reconfiguration procedure. The RRC connection reconfiguration procedure includes the BS sending an RRC connection reconfiguration message to the UE and the UE sending an RRC connection reconfiguration-complete message to the BS. The RRC connection reconfiguration message may include a secondary serving cell configuration information field including contents regarding the configuration of a secondary serving cell added to the UE. Both the RRC connection reconfiguration message and the RRC connection reconfiguration-complete message are transmitted and received on a primary serving cell. The secondary serving cell configuration procedure may be performed when a BS receives a request for more radio resources from UE or a network or when a BS determines that more radio resources are necessary.

The one or more secondary serving cells configured in the UE may be classified into the same TAG as a primary serving cell or may be classified into an independent TAG. If one or more secondary serving cells configured depending on UE are classified as an independent TAG, it corresponds to a case where a BS has not obtained clear information on whether the one or more secondary serving cells belong to what pTAG.

The BS sends a MAC message, including an activation indicator that activates some or all of the one or more secondary serving cells configured in the UE and TAG configuration information, to the BS at step S510. The TAG configuration information may be included in a MAC message and transmitted. The MAC message may also be called a MAC Protocol Data Unit (PDU). The MAC message includes at least one MAC Control Element (CE). The MAC control element may include an activation indicator and TAG configuration information. When the BS activates some or all of the secondary serving cells, the BS can allocate resources for the secondary serving cells configured in the UE.

A MAC message may include or may not include TAG configuration information. For example, if there is a secondary serving cell which may have a different timing alignment value from a pTAG, a BS can configure an sTAG including only the secondary serving cell. In this case, a MAC message may include TAG configuration information on the pTAG and the sTAG. For another example, if there is a secondary serving cell having a different timing alignment value, from among secondary serving cells that belong to a pTAG or an sTAG, a BS may configure a new sTAG having a different timing alignment value or may include the secondary serving cell, having the different timing alignment value, in a pTAG or an sTAG that has the same timing alignment value as the secondary serving cell. In this case, a MAC message may include TAG configuration information including information on the new sTAG or configuration information on the reconfigured TAG.

The UE configures a timing reference serving cell within each TAG at step S515. Here, information on the timing reference serving cell may be or may not be included in the TAG configuration information. The timing reference serving cell may become a component carrier unit not a serving cell unit. In this case, a downlink timing reference serving cell may also be called a downlink timing reference component carrier. Furthermore, the timing reference component carrier may be separately designated as a downlink component carrier or an uplink component carrier. Thus, the UE can apply the timing alignment value, received from the BS, to each TAG.

The timing reference serving cell may also be used as a representative serving cell which performs the random access procedure at step S520. For example, if information on a timing reference serving cell is not included in TAG configuration information, the representative serving cell may be defined as a cell that a BS has first instructed the cell to perform a random access procedure in order to obtain the first uplink time alignment value for a corresponding sTAG. For another example, if a Time Alignment Timer (TAT) within an sTAG has expired and thus a timing alignment value is not valid, the configuration of a representative serving cell has been released.

A timing reference serving cell may have the following characteristics. i) There is one timing reference serving cell in each TAG. ii) A timing reference serving cell within a pTAG is a primary serving cell. iii) Only secondary serving cells or a primary serving cell within an sTAG may be configured in a timing reference serving cell within the TAG. iv) In the case of an sTAG, a timing reference serving cell may be changed.

The UE can perform a random access procedure for obtaining a timing alignment value at step S520. The UE can obtain a valid timing alignment value based on a timing reference serving cell within each TAG through the random access procedure. A random access procedure for securing the timing alignment value of a newly configured sTAG is initiated by an order of a BS. In this case, UE has to receive a random access start indicator indicating the start of the random access procedure on a specific serving cell from the BS. The specific serving cell may be a representative serving cell within the newly configured sTAG. The random access procedure may be based on non-contention or may be based on contention. The non-contention-based random access procedure may be initiated by an order of a BS to perform a random access procedure. Furthermore, the contention-based random access procedure may be initiated when UE sends a randomly selected random access preamble to a BS.

There may be a case where a BS has recognized that there are secondary serving cells having a different timing alignment value from a pTAG, but does not know that the secondary serving cells belong to which sTAG. In this case, if the BS sends TAG configuration information, including information on a new sTAG including the secondary serving cells, and an activation indicator for the secondary serving cells to UE, the UE can rapidly receive a random access start indicator for the secondary serving cells within the new sTAG from the BS and also secure uplink synchronization in the sTAG to which a corresponding secondary serving cell belongs.

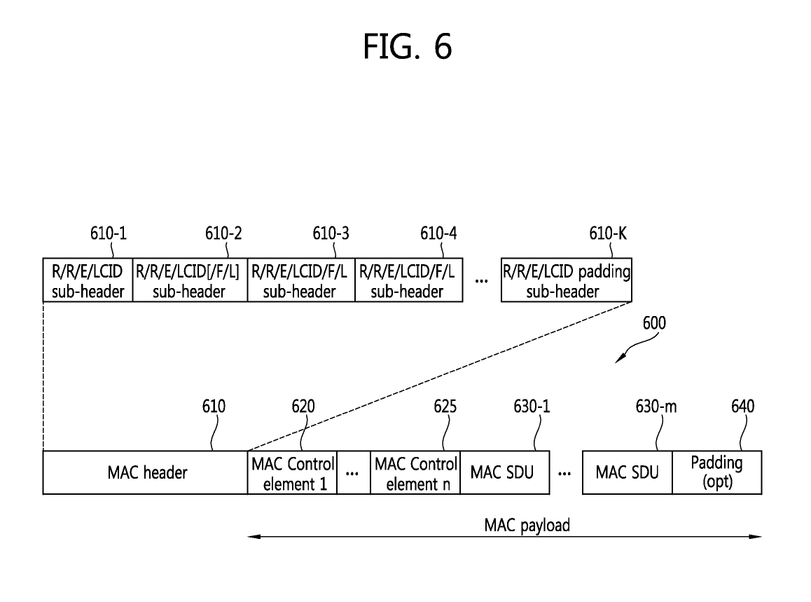

FIG. 6 shows the structure of a MAC message in accordance with an example of the present invention.

Referring to FIG. 6, the MAC message 600 includes a MAC header 610, one or more MAC control elements 620 to 625, one or more MAC Service Data Units (SDUs) 630-1 to 630-m, and padding 640.

The MAC header 610 includes one or more sub-headers 610-1, 610-2 to 610-k. Each of the sub-headers 610-1, 610-2 to 610-k corresponds to one MAC SDU or one MAC control element 620 to 625 or one padding 640. Sequence of the sub-headers 610-1, 610-2 to 610-k is the same as that of the MAC SDU, the MAC control elements 620 to 625, or the padding 640 within the MAC message 600.

Each of the sub-headers 610-1, 610-2 to 610-k may include four fields R, R, E, and Logical Channel ID (LCID) or may include six fields R, R, E, LCID, F, and L. The sub-header including the four fields is a sub-header corresponding to the MAC control elements 620 to 625 or the padding 640, and the sub-header including the six fields is a sub-header corresponding to the MAC SDU.

An LCID field is an ID field to identify a logical channel corresponding to a MAC SDU or to identify the type of MAC control elements 620 to 625 or padding. When each of the sub-headers 610-1, 610-2 to 610-k has an octet structure, an LCID field may have 5 bits.

For example, an LCID field can identify whether or not the MAC control elements 620 to 625 are MAC control elements for indicating the activation or deactivation of a serving cell and a TAG configuration (hereinafter referred to as MAC control elements regarding activation and a TAG configuration (activation & TAG MAC CE)) as in Table 1.

TABLE 1

| LCID INDEX | LCID VALUE |
|---|---|
| 00000 | CCCH |
| 00001-01010 | ID of logical channel |
| 01011-11010 | Reserved |
| 11011 | Activation/deactivation and TAG configuration |
| 11100 | UE contention resolution ID |
| 11101 | Timing Advance Command (TAC) |
| 11110 | DRX order |
| 11111 | Padding |

Referring to Table 1, if the value of the LCID field is 11011, a corresponding MAC control element is a MAC control element regarding activation/deactivation and a TAG configuration. That is, a MAC control element configured through one sub-header, that is, one LCID field, can indicate both an activation/deactivation indicator and a TAG configuration.

In some embodiments, an LCID field may identify whether the MAC control elements 620 to 625 are MAC control elements regarding a TAG configuration or MAC control elements regarding the activation/deactivation of a serving cell, as in Table 2.

TABLE 2

| LCID INDEX | LCID VALUE |
|---|---|
| 00000 | CCCH |
| 00001-01010 | ID of logical channel |
| 01011-11001 | Reserved |
| 11010 | TAG configuration |
| 11011 | Activation/deactivation |
| 11100 | UE contention resolution ID |
| 11101 | Timing Advance Command (TAC) |
| 11110 | DRX order |
| 11111 | Padding |

Referring to Table 2, if the value of an LCID field is 11010, a corresponding MAC control element is a MAC control element regarding a TAG configuration. Furthermore, if the value of an LCID field is 11011, a corresponding MAC control element is a MAC control element regarding activation/deactivation.

The MAC control elements 620 to 625 are control messages generated by a MAC layer. The padding 640 is a specific number of bits that are added to make regular the size of the MAC message. All the MAC control elements 620 to 625, the MAC SDUs 630-1 to 630-m, and the padding 640 are also collectively called a MAC payload. Some examples of MAC control elements regarding activation and a TAG configuration are disclosed.

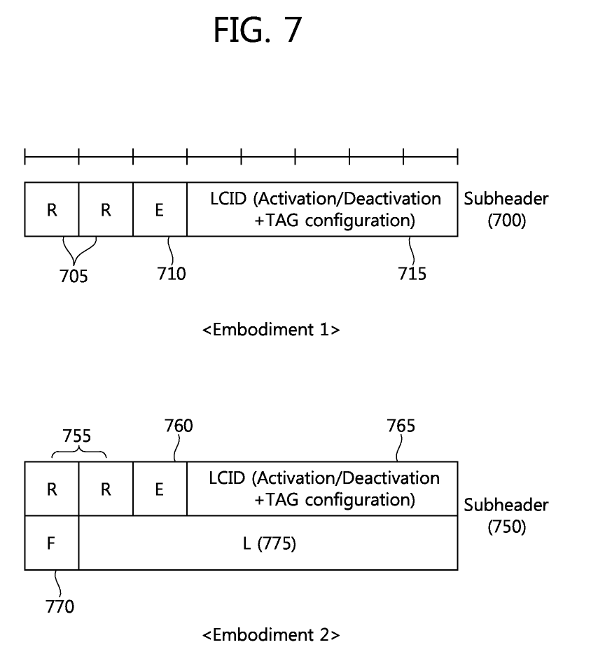

FIG. 7 is a block diagram showing the structure of a MAC control element in accordance with an example of the present invention. This figure shows the structure of the MAC control element regarding activation/deactivation and a TAG configuration.

In an embodiment 1 of FIG. 7, a sub-header 700 includes two R fields 705, an E field 710, and an LCID field 715. The LCID field 715 may correspond to a MAC control element regarding activation and a TAG configuration when it has a value of 11011 as in Table 1, for example.

In an embodiment 2 of FIG. 7, a sub-header 750 includes two R fields 755, an E field 760, an LCID field 765, an F field 770, and an L field 775. The LCID field 715 may correspond to a MAC control element regarding activation and a TAG configuration when it has a value of 11011 as in Table 1, for example. If a MAC control element regarding activation and a TAG configuration is configured as described above, the LCID fields 715 and 765 of the sub-headers 700 and 750 may be set to new LCID values.

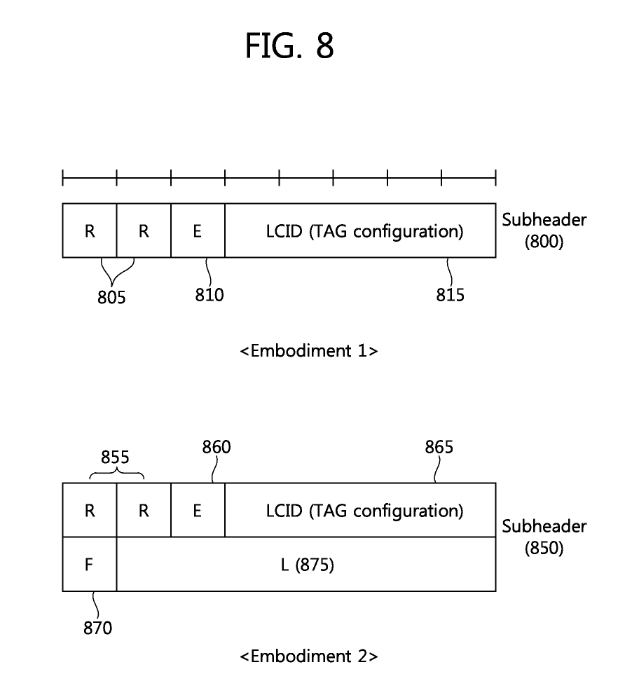

FIG. 8 is a block diagram showing the structure of a MAC control element in accordance with another example of the present invention. This figure shows the structure of the MAC control element regarding a TAG configuration.

In an embodiment 1 of FIG. 8, a sub-header 800 includes two R fields 805, an E field 810, and an LCID field 815. The LCID field 815 corresponds to a MAC control element regarding a TAG configuration when it has a value of 11010 as in Table 2, for example.

In an embodiment 2 of FIG. 8, a sub-header 850 includes two R fields 855, an E field 860, an LCID field 865, an F field 870, and an L field 875. The LCID field 815 corresponds to a MAC control element regarding a TAG configuration when it has a value of 11010 as in Table 2, for example.

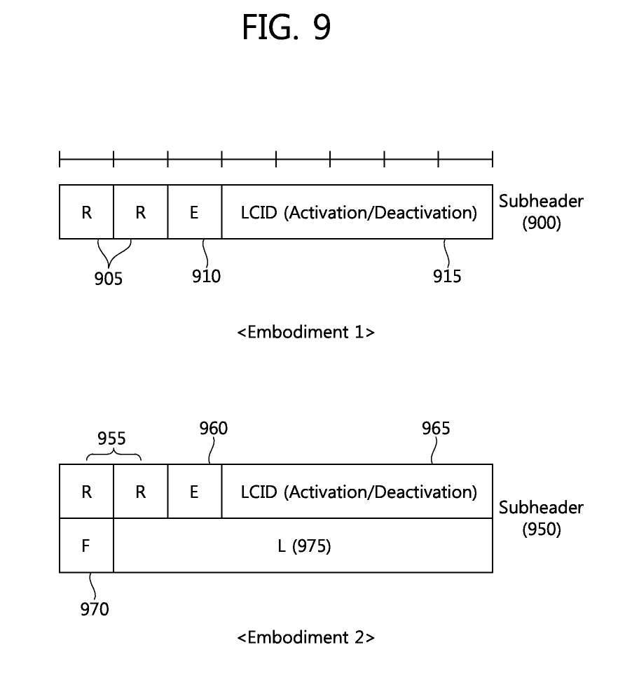

FIG. 9 is a block diagram showing the structure of a MAC control element in accordance with yet another example of the present invention. This figure shows the structure of the MAC control element regarding activation/deactivation.

In an embodiment 1 of FIG. 9, a sub-header 900 includes two R fields 905, an E field 910, and an LCID field 915. The LCID field 915 corresponds to a MAC control element regarding activation/deactivation when it has 11011 as in Table 2, for example.

In an embodiment 2 of FIG. 9, a sub-header 950 includes two R fields 955, an E field 960, an LCID field 965, an F field 970, and an L field 975. The LCID field 915 corresponds to a MAC control element regarding activation/deactivation when it has 11011 as in Table 2, for example.

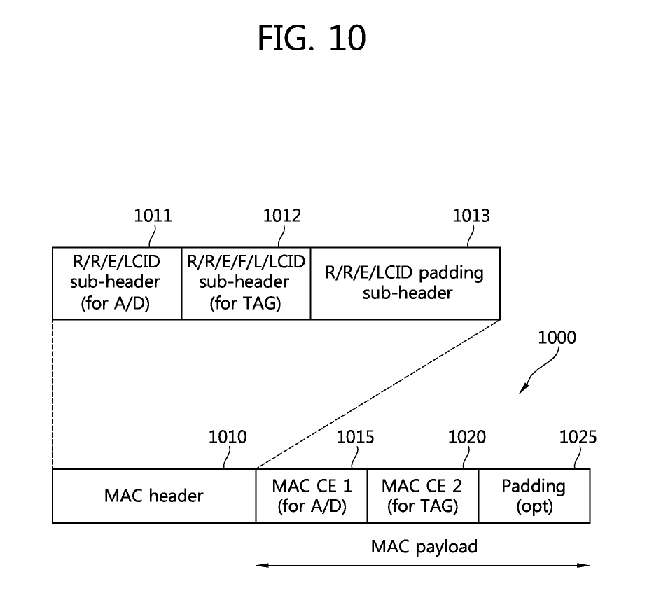

FIG. 10 shows the structure of a MAC message in accordance with another example of the present invention.

Referring to FIG. 10, the MAC message 1000 includes a MAC header 1010, a first MAC control element MAC CE1 1015, a second MAC control element MAC CE2 1020 and padding 1025.

The MAC header 1010 includes a plurality of sub-headers and includes a first sub-header 1011, a second sub-header 1012, and a third sub-header 1013. The MAC header 1010 is illustrated as including only three sub-headers, but this is only illustrative. The number of sub-headers when a MAC header is actually embodied may be less than 3 or more than 3. The first sub-header 1011 includes an R field, an E field, and an LCID field. The LCID field corresponds to the first MAC control element 1015, that is, a MAC control element regarding activation/deactivation, as in Table 2. That is, the value of the LCID field within the first sub-header 1011 is 11011. Meanwhile, the second sub-header 1012 includes an R field, an E field, an F field, an L field, and an LCID field. The LCID field corresponds to the second MAC control element 1020, that is, a MAC control element regarding a TAG configuration, as in Table 2. Here, the value of the LCID field within the second sub-header 1012 is 11010.

The first sub-header 1011 and the second sub-header 1012 are disposed within the structure of the MAC header 1010 contiguously or non-contiguously. A BS may configure a MAC message so that a MAC control element regarding activation/deactivation and a MAC control element regarding a TAG configuration are separated from each other and included in one MAC message as described above, but they are indicated by different LCID fields.

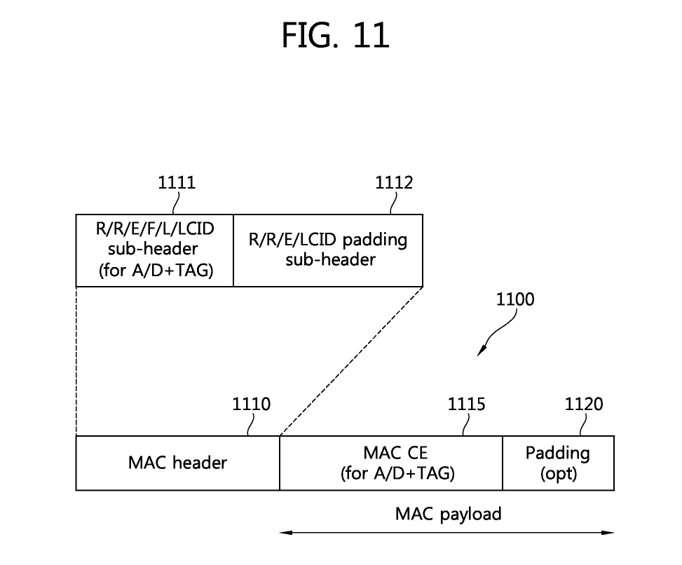

FIG. 11 shows the structure of a MAC message in accordance with yet another example of the present invention.

Referring to FIG. 11, the MAC message 1100 includes a MAC header 1110, a MAC control element MAC CE1 1115, and padding 1120. Meanwhile, the MAC header 1110 includes a plurality of sub-headers, and it is illustrated as including a first sub-header 1111 and a second sub-header 1112. The MAC header 1110 is illustrated as including only two sub-headers, but this is only illustrative. The number of sub-headers when a MAC header is actually embodied may be less than 2 or more than 2.

The first sub-header 1111 includes an R field, an E field, an F field, an L field, and an LCID field. The LCID field corresponds to the first MAC control element 1115, that is, a MAC control element regarding activation and a TAG configuration, as in Table 1. That is, the value of the LCID field within the first sub-header 1111 is 11011.

The E field is used for UE to determine whether a MAC control element is related to activation/deactivation because the value of the LCID field according to Table 2 is 11011 or whether a MAC control element is related to a TAG configuration according to Table 2 because the value of the LCID field is 11010. This is because the L field may be added to a sub-header in relation to a MAC control element that may have a variable length. Accordingly, if the E field is ‘1’, next 8 bits include the F field of 1 bit and the L field of 7 bits which are added to a corresponding sub-header.

The L field indicates the length of a MAC control element or a MAC SDU that may have a variable length. A unit indicative of the length of the MAC control element or the MAC SDU is 1 byte. Accordingly, if the L field is 0000010, the length of a MAC control element that may have a variable length is 2 bytes (16 bits). The F field is set to 0 if it includes information smaller than 128 bytes, that is, the maximum length of the L field that can be represented. In other cases, the F field is set to 1.

Accordingly, a MAC sub-header including an L field corresponds to a MAC control element regarding activation and a TAG configuration. Furthermore, if a MAC control element includes only TAG configuration information, a case where the TAG configuration information includes information of 16 bits or higher is also used. Accordingly, UE can know whether an L field exists or not through an E field and know the total length (bit length) of a corresponding MAC control element based on information on the L field.

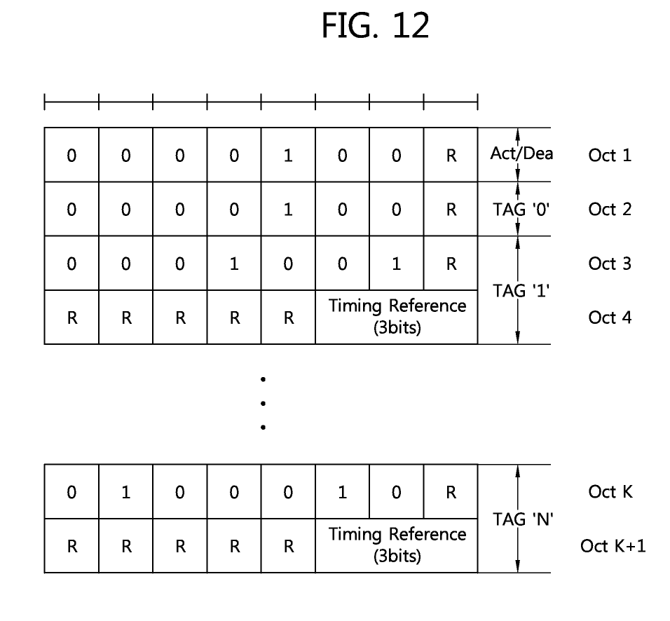

FIG. 12 shows the structure of a MAC control element regarding activation and a TAG configuration in accordance with an example of the present invention.

Referring to FIG. 12, the MAC control element regarding activation and a TAG configuration includes an octet 1 OCT 1 to an octet K+1 OCT K+1. One octet has 8 bits and includes information on activation and a TAG configuration. The octet 1 OCT1 is allocated to an activation indicator. The position of each of the bits of the activation indicator is mapped to a serving cell index ServCell-index or a secondary serving cell index SCell-index. When the value of a bit is 0, it indicates that a serving cell mapped to the bit is deactivated. When the value of a bit is 1, it indicates that a serving cell mapped to the bit is activated. A Most Significant Bit (MSB) means an index 7. Meanwhile, a Least Significant Bit (LSB) includes reserved bits. This is because a primary serving cell is always activated and thus to indicate activation/deactivation using an activation indicator is meaningless.

Each of the octet 2 (OCT 2) to the octet K+1 (OCT K+1) includes TAG configuration information. Assuming that TAGs configured in UE include a TAG ‘0’, a TAG ‘1’ to a TAG ‘N’, an indicator to indicate a serving cell included in each TAG includes 8 bits.

First, the TAG ‘0’ is a pTAG, and configuration information on the TAG ‘0’ is allocated to only one octet (e.g., the octet 2 OCT 2). The position of each bit is mapped to a serving cell index ServCell-index or a secondary serving cell index SCell-index. An LSB means an index 0, and an MSB means an index 7. Meanwhile, the LSB includes reserved bits. The timing reference serving cell of the TAG ‘0’ is a primary serving cell. Accordingly, although a primary serving cell is not represented in the configuration information bit stream of the TAG ‘0’, the primary serving cell may be considered to be included in the TAG ‘0’ implicitly. Likewise, although a primary serving cell is not represented in the configuration information bit stream of the TAG ‘N’, the primary serving cell may be considered not to be included in the TAG ‘N’ implicitly. Furthermore, there is no timing reference field indicative of a timing reference serving cell for the TAG ‘0’. Accordingly, 8 bits are always allocated to configuration information on the TAG ‘0’.

Next, the TAG ‘1’ to the TAG ‘N’ are sTAGs. Each of the pieces of configuration information on the TAG ‘1’ to the TAG ‘N’ is allocated to two octets. For example, the configuration information on the TAG ‘1’ may be allocated to the octet 3 OCT 3 and the octet 4 OCT 4, and the configuration information on the TAG ‘N’ may be allocated to the octet K OCT K and the octet K+1 OCT K+1.

The configuration information on the TAG ‘1’ includes a serving cell indication field of 7 bits indicative of a serving cell included in the TAG ‘1’, a reserved bit of 1 bit, a timing reference field of 3 bits indicative of the timing reference serving cell of the TAG ‘1’, and a reserved field of 5 bits. That is, a total of 16 bits are allocated to configuration information on one sTAG. Likewise, the configuration information on the TAG ‘N’ includes a serving cell indication field of 7 bits indicative of a serving cell included in the TAG ‘N’, a reserved bit of 1 bit, a timing reference field of 3 bits indicative of the timing reference serving cell of the TAG ‘N’, and a reserved field of 5 bits.

The timing reference field can indicate serving cells of 2³=8 in number because it has 3 bits. That is, the timing reference field can indicate the index of a serving cell designated as a timing reference serving cell, from among a maximum of 8 serving cells. A timing reference field is illustrated as including 3 bits, but various numbers of bits may be used to configure the timing reference field.

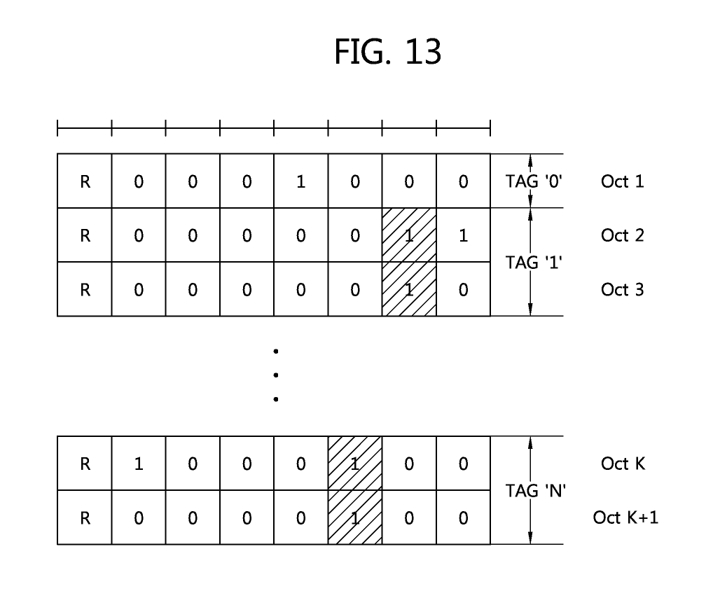

FIG. 13 shows the structure of a MAC control element regarding a TAG configuration in accordance with an example of the present invention.

Referring to FIG. 13, the MAC control element regarding a TAG configuration includes an octet 1 (OCT 1) to an octet K+1 (OCT K+1). One octet has 8 bits and includes information on a TAG configuration.

First, a TAG ‘0’ is a pTAG, and configuration information on the TAG ‘0’ is allocated to only one octet (e.g., the octet 1 (OCT 1)). The position of each bits is mapped to a serving cell index ServCell-index or a secondary serving cell index SCell-index. An LSB means an index 0, and an MSB means an index 7. Meanwhile, the MSB includes a reserved bit. The timing reference serving cell of the TAG ‘0’ is a primary serving cell. Accordingly, although a primary serving cell is not represented in the configuration information bit stream of the TAG ‘0’, the primary serving cell may be considered to be included in the TAG ‘0’ implicitly. Likewise, although a primary serving cell is not represented in the configuration information bit stream of the TAG ‘N’, the primary serving cell may be considered not to be included in the TAG ‘N’ implicitly.

Next, a TAG ‘1’ to a TAG ‘N’ are sTAGs, and two octets are allocated to each of configuration information on the TAG ‘1’ to the TAG ‘N’. For example, the configuration information on the TAG ‘1’ is allocated to the octet 2 OCT 2 and the octet 3 OCT 3, and the configuration information on the TAG ‘N’ is allocated to the octet K OCT K and the octet K+1 OCT K+1.

The configuration information on the TAG ‘1’ includes the serving cell indication field OCT 2 of 8 bits indicative of a serving cell included in the TAG ‘1’ and the timing reference field OCT 3 of 8 bits indicative of the timing reference serving cell of the TAG ‘1’. That is, a total of 16 bits is allocated to configuration information on one sTAG. Likewise, the configuration information on the TAG ‘N’ includes a serving cell indication field OCT K of 8 bits indicative of a serving cell included in the TAG ‘N’ and a timing reference field OCT K+1 of 8 bits indicative of the timing reference serving cell of the TAG ‘N’.

Here, the timing reference field is a bitmap form, and each of bits is mapped to one unique serving cell. Accordingly, if a bit at a specific position is 1, it indicates that a serving cell to which the bit is mapped is a timing reference serving cell. If a bit at a specific position is 0, it indicates that a serving cell to which the bit is not a timing reference serving cell. The timing reference field has the same form as a serving cell indication field. The timing reference field has to indicate only one of serving cells included in a corresponding TAG. That is, only one of 8 bits is set to 1, and all the remaining bits are set to 0.

A BS should inform UE of information on a serving cell, that is, a reference that is used for the UE to measure pathloss. A serving cell, that is, a reference used to measure pathloss, is a pathloss reference serving cell. The pathloss reference serving cell may be configured for each serving cell or for each TAG. The pathloss reference serving cell may be fixedly configured as a downlink component carrier with which connection has been set up with an uplink center frequency within a System Information Block 2 (SIB2) regarding the pathloss reference serving cell. The downlink component carrier is hereinafter referred to as an ‘SIB2-linked downlink component carrier’.

For example, information on a pathloss reference serving cell may be included in an RRC message and transmitted from a BS to UE. In the case of serving cells within a pTAG, a range of serving cell that may be indicated by the RRC message may be limited to a primary serving cell or an SIB2-linked downlink component carrier. Furthermore, in the case of serving cells within an sTAG, a range of serving cell that may be indicated by the RRC message may be fixed to an SIB2-linked downlink component carrier or may be limited to secondary serving cells within a corresponding sTAG.

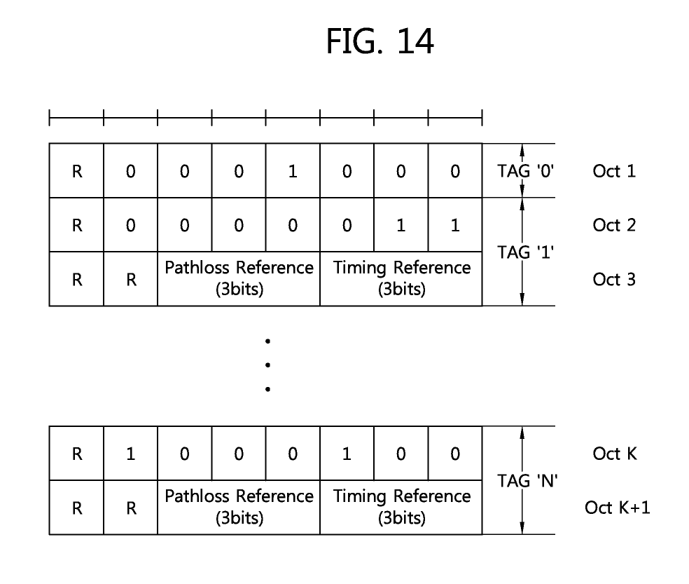

For another example, information on a pathloss reference serving cell may be transmitted from a BS to UE in the form of a MAC message. For example, a pathloss reference serving cell may be defined in the same manner as a timing reference serving cell within a MAC message. In this case, a MAC control element regarding a TAG configuration includes only a timing reference field. A serving cell indicated by the timing reference field is a timing reference serving cell and also a pathloss reference serving cell. In some embodiments, a pathloss reference serving cell may be defined separately from a timing reference serving cell within a MAC message. This is because a criterion for determining a pathloss reference and a criterion for determining a timing reference may be differently set. A MAC control element regarding a TAG configuration includes a timing reference field and a pathloss reference field. This is described in detail more with reference to FIG. 14.

FIG. 14 shows the structure of a MAC control element regarding a TAG configuration in accordance with another example of the present invention.

Referring to FIG. 14, the MAC control element regarding a TAG configuration includes an octet 1 (OCT 1) to an octet K+1 (OCT K+1). One octet has 8 bits and includes information on a TAG configuration.

First, a TAG ‘0’ is a pTAG, and configuration information on the TAG ‘0’ is allocated to only one octet (e.g., the octet 1). The position of each bit is mapped to a serving cell index ServCell-index or a secondary serving cell index SCell-index. An LSB means an index 0, and an MSB means an index 7. Meanwhile, the MSB includes a reserved bit. The timing reference serving cell of the TAG ‘0’ is a primary serving cell. Accordingly, although a primary serving cell is not represented in the configuration information bit stream of the TAG ‘0’, the primary serving cell may be considered to be included in the TAG ‘0’ implicitly. Likewise, although a primary serving cell is not represented in the configuration information bit stream of the TAG ‘N’, the primary serving cell may be considered not to be included in the TAG ‘N’ implicitly.

Next, a TAG ‘1’ to the TAG ‘N’ are sTAGs, and configuration information on of each of the TAG ‘1’ to the TAG ‘N’ is allocated to two octets. For example, configuration information on the TAG ‘1’ may be allocated to the octet 2 (OCT 2) and the octet 3 (OCT 3), and configuration information on the TAG ‘N’ may be allocated to the octet K (OCT K) and the octet K+1 (OCT K+1).

Configuration information on the TAG ‘1’ includes a serving cell indication field OCT 2 of 8 bits indicative of a serving cell included in the TAG ‘1’, a timing reference field of 3 bits indicative of the timing reference serving cell of the TAG ‘1’, and a pathloss reference field OCT 3 of 3 bits indicative of the pathloss reference serving cell of the TAG ‘1’. The remaining bits are set as an R field. That is, a total of 16 bits are allocated to configuration information on one sTAG. Likewise, the configuration information on the TAG ‘N’ includes a serving cell indication field OCT K of 8 bits indicative of a serving cell included in the TAG ‘N’, a timing reference field of 3 bits indicative of the timing reference serving cell of the TAG ‘N’, and a pathloss reference field OCT K+1 of 3 bits indicative of the pathloss reference serving cell of the TAG ‘N’.

The timing reference field can indicate 2³=8 serving cells because it has 3 bits. That is, the timing reference field can indicate the index of a serving cell designated as a timing reference serving cell, from among a maximum of 8 serving cells. Furthermore, since the pathloss reference field has 3 bits, it can indicate 2³=8 serving cells. That is, the pathloss reference field can indicate the index of a serving cell designated as a pathloss reference serving cell, from among a maximum of 8 serving cells. Although each of the timing reference field and the pathloss reference field has been illustrated as having 3 bit, various numbers of bits can be used in the constructions of the timing reference field and the pathloss reference field.

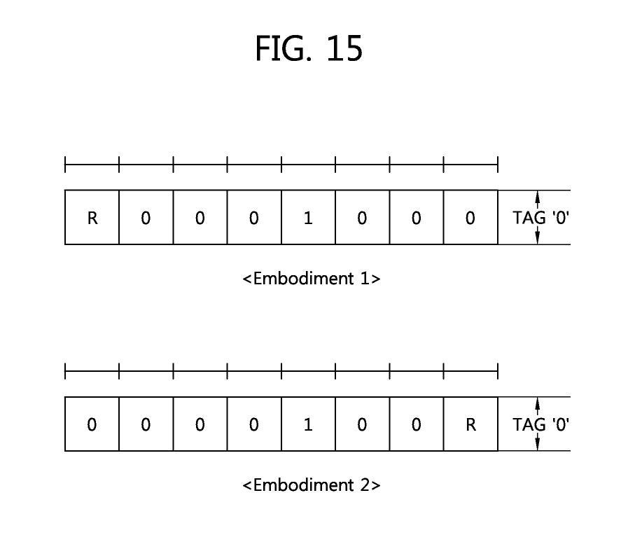

FIG. 15 shows the structure of a MAC control element regarding a TAG configuration in accordance with yet another example of the present invention.

Referring to FIG. 15, configuration information on a TAG may include only a serving cell indication field indicative of serving cells included in the TAG. That is, unlike in the embodiment of FIG. 14, the configuration information on a TAG does not include a timing reference field or a pathloss reference field. This may correspond to a case where information on a timing reference serving cell or information on a pathloss reference serving cell is transmitted through RRC signaling or a case where a BS defines a serving cell, first indicating a random access procedure after configuring the TAG, as a timing reference serving cell and a pathloss reference serving cell.

Meanwhile, if the maximum number of TAGs that can be configured in UE is limited to 2 and two TAGs are actually configured in the UE, a BS may send a MAC control element, including only configuration information on a pTAG as in the embodiment 1 or the embodiment 2, to the UE. In contrast, configuration information on different TAGs other than the pTAG is not included in the MAC control element. That is, configuration information on one TAG may be omitted in the MAC control element. Accordingly, there is an advantage in that UE can be informed of configuration information on two TAGs through only one octet (i.e., 8 bits). In this case, the UE configures a serving cell, not belonging to the pTAG, as an sTAG. In the embodiment 1, secondary serving cells are sequentially mapped to a secondary serving cell1, a secondary serving cell2, . . . , a secondary serving cell7 from an LSB to an MSB. Sequence of the secondary serving cells mapped to the serving cell indication field is not limited to the above order.

In the embodiment 1, only bits mapped to the secondary serving cell4 are 1, and all the remaining bits are 0. That is, the TAG ‘0’ includes a primary serving cell and a secondary serving cell4. If a primary serving cell, a secondary serving cell1, a secondary serving cell2, and a secondary serving cell4 are configured in UE, the secondary serving cell and the secondary serving cell2 not belonging to the TAG ‘0’ are included in the TAG ‘1’, that is, an sTAG, because the primary serving cell and the secondary serving cell4 configure the TAG ‘0’.

If the TAG ‘0’ includes all secondary serving cells configured in UE, the UE can configure the TAG ‘1’ as an empty sTAG. The empty sTAG can be configured in the following situations: i) When all secondary serving cells within an sTAG are released and ii) when all the uplink component carriers of secondary serving cells within an sTAG are released.

In the embodiment 2, unlike in the embodiment 1, the position of an R field indicates a MAC control element when it is placed in an LSB.

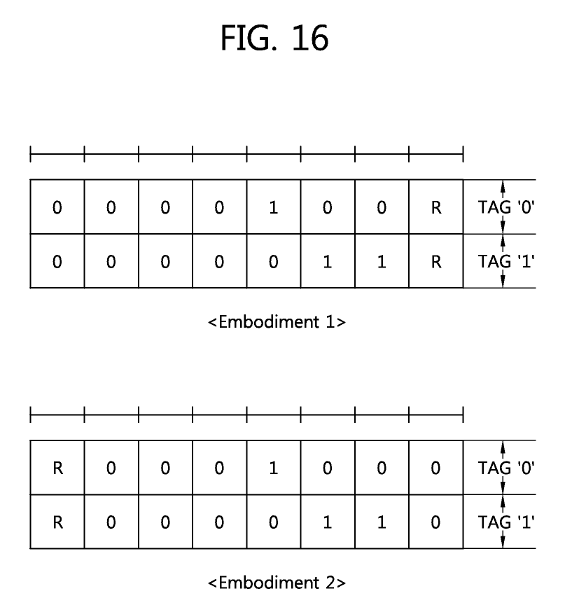

FIG. 16 shows the structure of a MAC control element regarding a TAG configuration in accordance with further yet another example of the present invention.

Referring to FIG. 16, configuration information on a TAG may include only a serving cell indication field indicative of serving cells included in the TAG. That is, unlike in the embodiment of FIG. 14, the configuration information on a TAG does not include a timing reference field or a pathloss reference field. This may correspond to a case where information on a timing reference serving cell or information on a pathloss reference serving cell is transmitted through RRC signaling or a case where a BS defines a serving cell, first indicating a random access procedure after configuring the TAG, as a timing reference serving cell and a pathloss reference serving cell.

Meanwhile, if the maximum number of TAGs that can be configured in UE is limited to K and three TAGs are actually configured in the UE, a BS may send a MAC control element, including only configuration information on a pTAG and configuration information on one sTAG, to the UE as in the embodiment 1 or the embodiment 2. In contrast, configuration information on different sTAGs other than the pTAG is not included in the MAC control element. That is, configuration information on one TAG may be omitted in the MAC control element. Accordingly, there is an advantage in that UE can be informed of configuration information on three TAGs through only two octets (i.e., 16 bits). In the embodiment 2, unlike in the embodiment 1, the position of an R field indicates a MAC control element when it is placed in an LSB.

The MAC control element including TAG configuration information in FIGS. 13 to 16 can be likewise applied to the structure of a MAC control element regarding activation and a TAG configuration, including an activation indicator, as in FIG. 12.

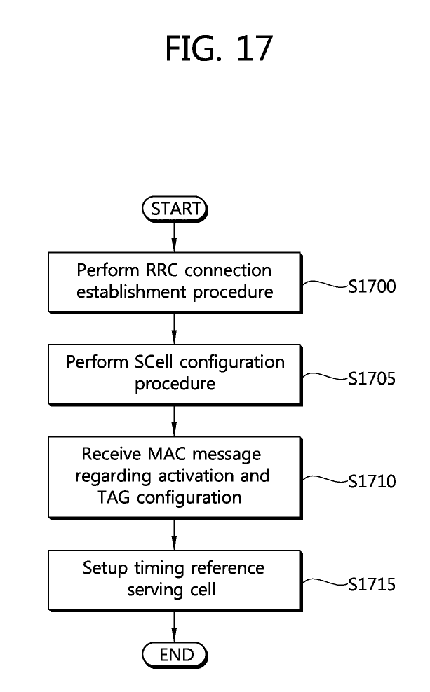

FIG. 17 is a flowchart illustrating a method of UE performing uplink synchronization in accordance with an example of the present invention.

Referring to FIG. 17, the UE performs an RRC connection establishment procedure with a BS at step S1700. The RRC connection establishment procedure includes the UE sending an RRC connection request message to the BS, the BS sending an RRC connection setup message to the UE, and the UE sending an RRC connection setup-complete message to the BS.

The UE performs a secondary serving cell configuration procedure for configuring one or more secondary serving cells in the UE at step S1705. The secondary serving cell configuration procedure can be performed through an RRC connection reconfiguration procedure. The RRC connection reconfiguration procedure may include the BS sending an RRC connection reconfiguration message to the UE and the UE sending an RRC connection reconfiguration-complete message to the BS. The RRC connection reconfiguration message may include a secondary serving cell configuration information field including contents regarding the secondary serving cells configured in the UE.

The UE receives a MAC message from the BS at step S1710. The MAC message may also be called a MAC PDU. The MAC message includes at least one MAC control element. The MAC control element includes any one of the structures shown in FIGS. 12 to 16. The MAC control element may be one MAC control element including activation and a TAG configuration, a MAC control element regarding activation, or a MAC control element regarding a TAG configuration. That is, the MAC message may include or may not include TAG configuration information. For example, if there is a secondary serving cell that may have a different timing alignment value from a pTAG, a BS may configure an sTAG including only the secondary serving cell. In this case, the MAC message may include TAG configuration information regarding the pTAG and the sTAG. For another example, if there is a secondary serving cell having a different timing alignment value, from among secondary serving cells belonging to one of a pTAG and an sTAG, a BS may configure a new sTAG having a different timing alignment value or may include the secondary serving cell having a different timing alignment value in a pTAG or an sTAG that has the same timing alignment value as the timing alignment value of the secondary serving cell. In this case, a MAC message may include TAG configuration information including information on the new sTAG or configuration information on the reconfigured TAG.

The UE configures a downlink timing reference serving cell within each TAG at step S1715. Thus, the UE can apply the timing alignment value, received from the BS, to a corresponding TAG. Here, information on the timing reference serving cell may be or may not be included in the TAG configuration information. The timing reference serving cell may become a component carrier unit not a serving cell unit. In this case, a downlink timing reference serving cell may also be called a downlink timing reference component carrier. Furthermore, the timing reference component carrier may be separately designated as a downlink component carrier or an uplink component carrier. The timing reference serving cell may be used as a representative serving cell that performs a random access procedure.

For example, if information on a timing reference serving cell is not included in the TAG configuration information, a BS may define the representative serving cell as a cell indicative of a random access procedure in order to obtain the first uplink time alignment value for a corresponding sTAG. For another example, if a TAT within a specific sTAG expires and thus a timing alignment value is invalid, the configuration of the representative serving cell may be released.

The timing reference serving cell can have the following characteristics. i) There is one timing reference serving cell in each TAG. ii) A timing reference serving cell within a pTAG is a primary serving cell. iii) Only a secondary serving cells or a primary serving cell within an sTAG can be set as a timing reference serving cell within the sTAG. iv) In the case of an sTAG, a timing reference serving cell can be changed.

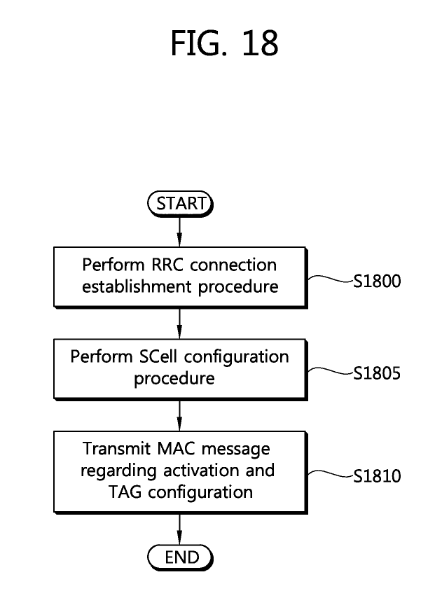

FIG. 18 is a flowchart illustrating a method of a BS performing uplink synchronization in accordance with an example of the present invention.

Referring to FIG. 18, the BS performs an RRC connection establishment procedure with UE at step S1800. The RRC connection establishment procedure includes the UE sending an RRC connection request message to the BS, the BS sending an RRC connection setup message to the UE, and the UE sending an RRC connection setup-complete message to the BS.

The BS performs a secondary serving cell configuration procedure for configuring one or more secondary serving cells in the UE at step S1805. The secondary serving cell configuration procedure may be performed through an RRC connection reconfiguration procedure. The RRC connection reconfiguration procedure includes the BS sending an RRC connection reconfiguration message to the UE and the UE sending an RRC connection reconfiguration-complete message to the BS. The RRC connection reconfiguration message may include a secondary serving cell configuration information field including contents regarding the secondary serving cells configured in the UE.

The BS sends a MAC message, including an activation indicator that activates some or all of the one or more secondary serving cells configured in the UE and TAG configuration information, to the UE at step S1810. The MAC message may also be called a MAC PDU. The MAC message includes at least one MAC control element. The MAC control element is a MAC control element regarding activation and a TAG configuration. The MAC control element includes any one of the structures shown in FIGS. 12 to 16.

The BS may inform the UE of a timing alignment value for each of one or more TAGs configured in the UE by performing a random access procedure with the UE at need.

The TAG configuration information may be included in an RRC message in addition to a MAC message and transmitted. Table 3 shows an example of an RRC message including the configuration information on the secondary serving cells.

TABLE 3
RRCConnectionReconfiguration-v1020-IEs ::= SEQUENCE {

| sCellToReleaseList-r10 | | |
|---|---|---|
| SCellToReleaseList-r10 | OPTIONAL, | -- Need ON |
| sCellToAddModList-r10 | | |
| SCellToAddModList-r10 | OPTIONAL, | -- Need ON |

| | |
|---|---|
| nonCriticalExtension | SEQUENCE { } |

| | |
|---|---|
| OPTIONAL | -- Need OP |

}
SCellToAddModList-r10 ::=SEQUENCE (SIZE (1..maxSCell-r10) OF SCellToAddMod-r10

| SCellToAddMod-r10 ::= | | SEQUENCE { |
|---|---|---|
| | sCellIndex-r10 | |
| | SCellIndex-r10, | |
| | cellIdentification-r10 | SEQUENCE { |

| | |
|---|---|
| physCellId-r10 | PhysCellId, |

| | |
|---|---|
| dl-CarrierFreq-r10 | ARFCN-ValueEUTRA |

| | | |
|---|---|---|
| } | | |
| | OPTIONAL, | -- Cond SCellAdd |

| | |
|---|---|
| radioResourceConfigCommonSCell-r10 | RadioResourceConfigCommonSCell-r10 |

| | |
|---|---|
| OPTIONAL, | -- Cond SCellAdd |

| | |
|---|---|
| radioResourceConfigDedicatedSCell-r10 | RadioResourceConfigDedicatedSCell-r10 |

| | |
|---|---|
| OPTIONAL, | -- Cond SCellAdd2 |

...

}

Referring to Table 3, an sCellToReleaseList-r10 field includes information on a list of secondary serving cells whose configuration will be released, and an sCellToAddModList-r10 field includes information on a list of secondary serving cells that will be additionally configured or information on a list of secondary serving cells whose configuration will be changed.

The sCellToAddModList-r10 field includes a set of one or more SCellToAddMod-r10 fields, and a maximum value of the one or more SCellToAddMod-r10 fields to be included is defined by a maxSCell-r10 field. The SCellToAddMod-r10 field includes a radioResourceConfigCommonSCell-r10 field, that is, common configuration information on all secondary serving cells that will be additionally configured or whose configuration will be changed, a radioResourceConfigDedicatedSCell-r10 field, that is, dedicated configuration information on a secondary serving cell, an sCellIndex-r10 field including UE-specific index information on secondary serving cells configured in UE, and a cellIdentification-r10 field including information used to distinguish secondary serving cells from each other in an LTE system.

A cellIdentification-r10 field includes a dl-CarrierFreq-r10 field including information on physical frequency resources and a physCellId-r10 field including logical cell index information.

Furthermore, in syntaxes noted (i.e., --) in Table 2, an SCellAdd syntax means that if a secondary serving cell is added, a corresponding field always is present and, if not, the corresponding field is absent. Furthermore, an SCellAdd2 syntax means that if a secondary serving cell is added, a corresponding field is always present and, if not, the corresponding field may be optionally present at need. An ‘Need ON’ syntax indicates that UE does not perform any operation if a corresponding field is absent in relation to an optionally present field. In a ‘Need OP’ syntax, if there is no a corresponding field in relation to an optionally present field, UE operates depending on detailed contents indicated in the description of the corresponding field. If the contents are absent, the UE does not perform any operation. A ‘Cond’ syntax is an abbreviation of ‘conditional’. For example, Cond SCellAdd means a case where a ‘secondary serving cell is newly added’.

Here, a UE-specific configuration information field RadioResourceConfigDedicatedSCell applied to a specific secondary serving cell includes a TAG index field TAG_index, that is, TAG configuration information, as in Table 4.

TABLE 4

| | |
|---|---|
| RadioResourceConfigDedicatedSCell ::= | SEQUENCE { |

| ... | |
|---|---|
| TAG_index | TAG_index OPTIONAL, -- Need OP, |

...

}

Referring to Table 4, TAG_index indicates the index field of a TAG to which a specific secondary serving cell belongs. If the TAG_index field is not configured for the specific secondary serving cell (i.e., a TAG_index field is absent in a RadioResourceConfigDedicatedSCell field), UE can implicitly recognize that the specific secondary serving cell belongs to a pTAG.

Table 5 shows another example of an RRC message including TAG configuration information (TAG-config) on a specific UE.

TABLE 5

| MAC-MainConfig ::= | | SEQUENCE { |
|---|---|---|
| | ... | |
| | tagToAddModList ::= | SEQUENCE(SIZE (1..maxTAG)) OF TAG-Config OPTIONAL, |

| -- Need ON, | | |
|---|---|---|
| tagToReleaseList TagToReleaseList | OPTIONAL, | -- Need ON |

| | |
|---|---|
| TAG-Config ::= | SEQUENCE { |

| | |
|---|---|
| tag_index | TAG_Index, |
| ServCells | BIT STRING (8), |

| | |
|---|---|
| timeAlignmentTimerDedicated | TimeAlignmentTimer |

| | |
|---|---|
| } | |
| TagToReleaseList ::= | SEQUENCE(SIZE (1..maxTAG)) OF TAG_Index |
| ... | |

}

Referring to Table 5, MAC-MainConfig is included in the RadioResourceConfigDedicated field, transmitted to UE through an RRC reconfiguration message. Furthermore, a tagToAddModList field indicates a list of at least one TAG that will be newly added or whose configuration will be changed, and a TAG-Config field is TAG configuration information on each of TAGs included in the list. Furthermore, a tagToReleaseModList field indicates a list of TAGs to be released. That is, the tagToAddModList field and the tagToReleaseModList field are used to configure one or more TAGs.

max TAG indicates a maximum number of TAGs that can be configured in UE and may have, for example, a value of 3. Accordingly, the tagToAddModList field may include TAG configuration information TAG-Config on a maximum of three TAGs. A pTAG cannot be included in the release list information. Furthermore, a TAG index field (tag_index) indicates the index of a corresponding TAG for the specific UE. For example, if the value of the TAG index field is 0, it means a pTAG. If the value of the TAG index field is a natural number other than 0, it means an sTAG.

An ServCells field includes information on a list of serving cells included in at least one TAG that will be newly added or whose configuration will be changed. A bit string (BIT STRING) that represents list information on the ServCells field may have a length of, for example, 8 bits and uses the same rule as a method of representing serving cells included in one TAG shown in FIGS. 15 and 16. The ServCells field is optionally present. That is, an embodiment of the present invention may include TAG configuration information TAG-Config without the ServCells field.

A dedicated TAT field timeAlignmentTimerDedicated indicates the value of a TAT regarding at least one TAG that will be newly added or whose configuration will be changed.

If a maximum number of TAGs configurable in UE is limited to 2 and two TAGs are actually configured in the UE, an RRC message including only TAG configuration information on a pTAG may be transmitted to the UE. In other words, TAG configuration information on different TAGs other than the pTAG is not included in the RRC message. In some embodiments, a BS sends an RRC message, including only TAG configuration information on an sTAG, to UE. In other words, TAG configuration information on a pTAG is not included in the RRC message. In this case, the tagToAddModList field includes TAG configuration information TAG-Config on at least one sTAG that will be newly added or whose configuration will be changed. That is, TAG configuration information on one TAG may be omitted from the RRC message. In this case, UE configures a serving cell, not belonging to a pTAG, as an sTAG.

Meanwhile, if a maximum number of TAGs configurable in UE is limited to K and three TAGs are actually configured in the UE, a BS may send an RRC message, including only TAG configuration information on a pTAG and TAG configuration information on one sTAG, to the UE. In other words, TAG configuration information on other sTAGs except the pTAG and the one sTAG is not included in the RRC message. In some embodiments, a BS may send an RRC message, including only TAG configuration information on an sTAG, to UE. In other words, TAG configuration information on a pTAG other than the sTAG is not included in the RRC message. In this case, the tagToAddModList field includes TAG configuration information TAG-Config on at least one sTAG that will be newly added or whose configuration will be changed. That is, TAG configuration information on one TAG may be omitted from the RRC message. Accordingly, there is an advantage in that UE can be informed of TAG configuration information on three TAGs through only information on two TAGs. Furthermore, max TAG-r11 may have a value of ‘a maximum number of configurable TAGs−1’.

The embodiments of Table 4 and Table 5 are illustrated as examples, but an embodiment of the present invention can include TAG configuration information having a combination of Table 4 and Table 5. For example, when a BS configures a secondary serving cell, the BS individually generates TAG configuration information corresponding to the secondary serving cell, and may generate the TAG configuration information in a form that includes both of the syntax of Table 4 and Table 5. The TAG configuration information on a specific UE including the syntax of Table 4 and Table 5 may include the index of an sTAG for the specific UE as in Table 4 and configuration information (e.g., the index of an added sTAG and the value of a TAT regarding the added sTAG) on the added sTAG that will be newly added or whose configuration will be changed as in Table 5.

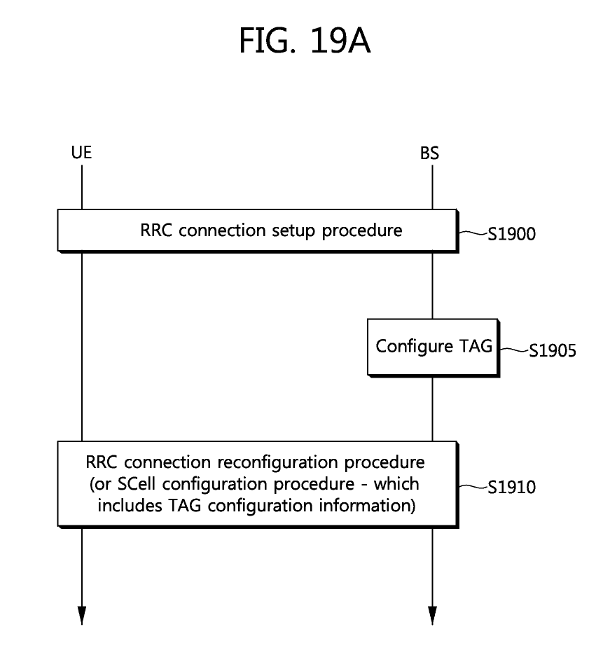

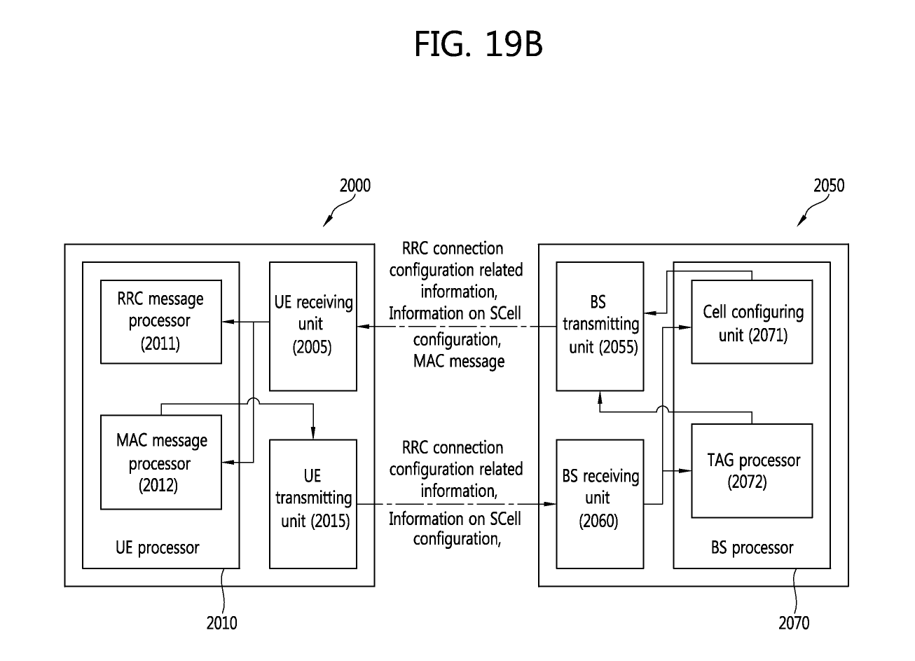

A process of sending an RRC message including TAG configuration information is described below with reference to FIG. 19A.

Referring to FIG. 19A, UE and a BS perform an RRC connection establishment procedure at step S1900. The RRC connection establishment procedure includes the UE sending an RRC connection setup request message to the BS, the BS sending an RRC connection setup message to the UE, and the UE sending an RRC establishment setup-complete message to the BS. The RRC connection establishment procedure includes the configuration of an SRB1. When the RRC connection establishment procedure is successfully completed, the UE can enter RRC-connected mode.

The BS configures a TAG at step S1905. The TAG may include a primary serving cell, one or more secondary serving cells, or a primary serving cell and one or more secondary serving cells. For example, the BS may configure a TAG in a UE-specific way. Configuration information on a serving cell is configured individually and independently for each UE, and thus the TAG can be configured individually and independently for each UE. For example, it is assumed that a TAG for first UE is TAG1_UE1 and TAG2_UE1 and a TAG for second UE is TAG1_UE2 and TAG2_UE2. If first and second serving cells are configured in the first UE, it results in TAG1_UE1={first serving cell} ad TAG2_UE1={second serving cell}. In contrast, if first to fourth serving cells are configured in the second UE, it may result in TAG1_UE2={first serving cell, second serving cell} and TAG2_UE2={third serving cell, fourth serving cell}.

For another example, the BS may configure the TAG in a manner specific or dedicated to a serving cell. A TAG may be configured on the basis of a cell irrespective of UE because information on the deployment of networks is determined irrespective of the UE. For example, it is assumed that a first serving cell having a specific frequency band is always served through a frequency selective repeater or a remote radio head and a second serving cell is served through a BS. In this case, in relation to all UEs within the service area of the BS, the first serving cell and the second serving cell are classified into different TAGs.

The BS performs an RRC connection reconfiguration procedure for reconfiguring the secondary serving cell or reconfiguring the TAG at step S1910. For example, the RRC connection reconfiguration procedure for reconfiguring the TAG includes the BS generating TAG configuration information, the BS sending an RRC connection reconfiguration message, including the generated TAG configuration information, to the UE, the UE performing an RRC connection reconfiguration process of reconfiguring a TAG, such as adding a new TAG to the UE or changing or removing the existing TAG, based on the TAG configuration information, and the UE sending the RRC connection reconfiguration-complete message to the BS.

In the above process, the BS generates the TAG configuration information as follows.

For example, a BS may generate TAG configuration information (TAG-config) including the TAG index field (TAG_index) to which a specific secondary serving cell belongs as in Table 4. In applying the generated TAG configuration information to the specific secondary serving cell, the BS may use a method of removing previous TAG configuration information on the specific secondary serving cell and setting up new TAG configuration information.

For another example, a BS may generate TAG configuration information (TAG-config), including the TAG index field (tag_index) indicative of at least one TAG that is newly added to a UE or whose configuration is changed and a dedicated TAT field (timeAlignmentTimerDedicated) indicative of the value of a TAT regarding the at least one TAG. Here, the TAG index is the index of an sTAG. That is, the BS may generate only TAG configuration information (i.e., sTAG-config) on an sTAG. In contrast, the BS does not include TAG configuration information on a pTAG other than the sTAG in the RRC connection reconfiguration message.

For yet another example, a BS may generate TAG configuration information having a combination of Table 4 and Table 5. For example, the BS individually generates TAG configuration information corresponding to the secondary serving cell, and may generate the TAG configuration information in a form that includes both of the syntax of Table 4 and Table 5. The TAG configuration information on a specific UE including the syntax of Table 4 and Table 5 may include the index of an sTAG for the specific UE, as in Table 4, and TAG configuration information on (e.g., the index of an added sTAG or the value of a TAT regarding an added sTAG) on at least one sTAG that is newly added or whose configuration is changed, as in Table 5.

Meanwhile, a process of UE reconfiguring a TAG, such as adding a new TAG or changing or removing the existing TAG, based on the TAG configuration information is as follows. From a viewpoint that the MAC layer of UE is reconfigured, the UE reconfigures TAG configuration of Medium Access Control (MAC) in accordance with TAG configuration information. For example, in relation to each of the TAG indices listed in the tagToAddModList field listed in Table 5, if i) a TAG indicated by a specific TAG index is not part of the current TAG configuration of UE, the UE adds the TAG to the specific TAG index. In relation to a TAT for the added TAG, the UE complies with the dedicated TAT field (timeAlignmentTimerDedicated) listed in Table 5. In contrast, if ii) a TAG indicated by a specific TAG index is part of the current TAG configuration of UE, the UE reconfigures the TAG in the specific TAG index. In relation to a TAT for the added TAG, the UE complies with the dedicated TAT field (timeAlignmentTimerDedicated) listed in Table 5. That is, the UE may apply the value of the TAT to the TAG indicated by the index of the TAG.

The RRC connection reconfiguration message may include TAG configuration information and the tagToAddModList field indicating a list of TAGs.

In some embodiments, UE which has received TAG configuration information may configure a TAG as follows. First, a primary serving cell is always included in a pTAG, and secondary serving cells in which a TAG index field has not been defined are elements within the pTAG. In contrast, secondary serving cells in which a TAG index field has been defined are included in an sTAG indicated by a corresponding TAG index.

FIG. 19B is a block diagram showing UE and a BS for performing a random access procedure in accordance with an example of the present invention.

Referring to FIG. 19B, the UE 2000 includes a UE receiver 2005, a UE processor 2010, and a UE transmitter 2015. The UE processor 2010 includes an RRC message processing unit 2011 and a MAC message processing unit 2012.

The UE receiver 2005 receives information on RRC connection establishment, information on the configuration of a secondary serving cell, and a MAC message from a BS 2050. The information on RRC connection establishment includes an RRC connection setup message. The information on the configuration of a secondary serving cell or TAG configuration information may be included in an RRC connection reconfiguration message.

The RRC message processing unit 2011 analyzes the RRC connection setup message and the RRC connection reconfiguration message and performs an RRC-related procedure based on a result of the analysis. For example, the RRC message processing unit 2011 may configure a secondary serving cell in the UE 2000 that must be added to the UE 2000. Furthermore, the RRC message processing unit 2011 may configure a TAG by adding a new TAG to the UE 2000 or changing or removing the existing TAG from the UE 2000 based on the TAG configuration information included in the RRC connection reconfiguration message. From a viewpoint that the MAC layer of the UE 2000 is reconfigured, the RRC message processing unit 2011 reconfigures a TAG configuration of a MAC in the UE in accordance with the TAG configuration information. For example, in relation to each of the TAG indices listed in the tagToAddModList field as in Table 5, if i) a TAG indicated by a specific TAG index is not part of the current TAG configuration of the UE 2000, the RRC message processing unit 2011 adds the TAG to the specific TAG index. In relation to a TAT for the added TAG, the RRC message processing unit 2011 complies with the dedicated TAT field timeAlignmentTimerDedicated as in Table 5. In contrast, if ii) a TAG indicated by a specific TAG index is part of the current TAG configuration of the UE 2000, the RRC message processing unit 2011 reconfigures the TAG in the specific TAG index. In relation to a TAT for the added TAG, the RRC message processing unit 2011 complies with the dedicated TAT field timeAlignmentTimerDedicated as in Table 5. The RRC message processing unit 2011 may apply the value of a TAT for a TAG indicated by the index of the TAG.

Furthermore, the RRC message processing unit 2011 may activate or deactivated the state of a secondary serving cell configured in the UE 2000 based on the activation indicator of the MAC message analyzed by the MAC message processing unit 2012.

The MAC message processing unit 2012 obtains TAG configuration information and an activation indicator for activating some or all of secondary serving cells configured in the UE 2000 by analyzing the MAC message received by the UE receiver 2005. The MAC message may also be called a MAC PDU, and it may have any one of the structures shown in FIGS. 6 to 11. The MAC message includes at least one MAC control element, and the MAC control element a MAC control element regarding activation and a TAG configuration. The MAC control element has any one of the structures shown in FIGS. 12 to 16.

The UE transmitter 2015 send an RRC connection request message, information on RRC connection establishment including an RRC connection setup-complete message, and an RRC connection reconfiguration-complete message to the BS 2050.

The BS 2050 includes a BS transmitter 2055, a BS receiver 2060, and a BS processor 2070. The BS processor 2070 includes a cell configuration unit 2071 and a TAG processing unit 2072.

The BS transmitter 2055 sends an RRC connection reconfiguration message including TAG configuration information, information on the configuration of a secondary serving cell, and a MAC message to the UE 2000.

The BS receiver 2065 receives an RRC connection setup request message, information on RRC connection establishment including an RRC connection setup-complete message, and an RRC connection reconfiguration-complete message from the UE 2000 and sends them to the cell configuration unit 2071.

The cell configuration unit 2071 determines a secondary serving cell that will be first configured in the UE 2000 or additionally configured in the UE 2000, generates configuration information on a secondary serving cell for configuring the determined secondary serving cell in the UE 2000, and sends the generated configuration information to the BS transmitter 2055.

The TAG processing unit 2072 determines the activation or deactivation of each secondary serving cell configured in the UE 2000 and determines a TAG that is configured in a manner specific to the UE 2000. Furthermore, the TAG processing unit 2072 generates TAG configuration information. For example, the TAG processing unit 2072 may generate TAG configuration information in order to reconfigure a maximum of three secondary (s) TAGs. Furthermore, the TAG processing unit 2072 may generate TAG configuration information in order to reconfigure the TAG configuration of a MAC of the UE 2000.

For example, the TAG processing unit 2072 may generate a MAC message, including TAG configuration information instructing that the activation indicator, indicative of the activation or deactivation of the determined secondary serving cell, and the determined TAG be configured in the UE 2000, and send the generated MAC message to the BS transmitter 2055.

For another example, the TAG processing unit 2072 may generate TAG configuration information in the form of an RRC message. For example, i) the TAG processing unit 2072 may generate S Cell specific-TAG configuration information (TAG-config) including the TAG index field (TAG_index) to which a specific secondary serving cell belongs as in Table 4. For another example, ii) the TAG processing unit 2072 may generate the TAG configuration information TAG-config, including the TAG index field (tag_index) indicating at least one TAG that is newly added or whose configuration is changed and the dedicated TAT field (timeAlignmentTimerDedicated) field indicative of the value of a TAT regarding the at least one TAG as in Table 5. Here, the TAG index is the index of an sTAG. That is, the BS 2050 may generate only TAG configuration information (i.e., sTAG-config) on the sTAG. In contrast, the BS 2050 does not include configuration information on a pTAG other than the sTAG in the RRC connection reconfiguration message. Furthermore, iii) the TAG processing unit 2072 may generate TAG configuration information having a combination of Table 4 and Table 5. For example, the TAG processing unit 2072 individually generates TAG configuration information on each secondary serving cell, and may generate the TAG configuration information in a form including both of the syntax of Table 4 and Table 5. The TAG configuration information regarding a specific UE including the syntax of Table 4 and Table 5 may include the index of an sTAG for the specific UE as in Table 4 and configuration information on at least one sTAG that is newly added or whose configuration is changed (e.g., the index of an added sTAG or the value of a TAT regarding an added sTAG) as in Table 5.

Meanwhile, the RRC connection reconfiguration message may further include the tagToAddModList field indicative of a list of TAGs as well as the TAG configuration information.

A variety of exemplary logic blocks, modules, and circuits described in connection with the disclosed embodiments may be controlled by general-purpose processors, Digital Signal Processors (DSPs), Application-Specific Integrated Circuits (ASICs), Field-Programmable Gate Arrays (FPGA) or other programmable logic devices, discrete gates or transistor logic, discrete hardware components, or a combination of them designed to perform the above-described functions. The control steps of the methods and algorithms described in connection with the disclosed embodiments may be directly embodied by hardware, software modules executed by processors, or a combination of them. In one or more exemplary embodiments, the above-described control functions may be embodied by hardware, software, firmware, or a combination of them. In software implementations, corresponding functions may be stored in a computer-readable medium or transmitted in the form of one or more instructions or codes.

As described above, UE can receive a random access start indicator rapidly and secure uplink synchronization in a corresponding secondary serving cell rapidly because a BS sends TAG configuration information and an activation indicator to the UE at the same time.

What is claimed is:

1. A method of a user equipment performing a Radio Resource Control (RRC) connection reconfiguration procedure in a multiple component carrier system, the method comprising:
receiving, from a base station, an RRC connection reconfiguration message used to reconfigure an RRC configuration in the user equipment, wherein the RRC connection reconfiguration message comprises TAG configuration information used to add, change or remove a Timing Advance Group (TAG) comprising one or more serving cells that use an identical timing advance value and an identical timing reference, from among serving cells in which an uplink component carrier is configured, and the TAG configuration information comprises TAG index information and information on a Time Advance Timer (TAT) value corresponding to the TAG;
performing an RRC connection reconfiguration based on the RRC connection reconfiguration message; and
transmitting, to the base station, an RRC connection reconfiguration completion message indicating the completion of the RRC connection reconfiguration,
wherein performing the RRC connection reconfiguration comprises:
reconfiguring, a TAG configuration of the user equipment with a specific TAG indicated by the TAG index information; and
applying the TAT value to the specific TAG.

2. The method of claim 1, wherein the TAG configuration information is used to reconfigure a maximum of three secondary TAG (sTAG).

3. The method of claim 1, wherein the TAG configuration information is used to reconfigure a TAG configuration of Medium Access Control (MAC) of the user equipment.

4. The method of claim 1, wherein reconfiguring the TAG configuration comprises:
adding the specific TAG, if the specific TAG is not part of a current TAG configuration of the user equipment.

5. The method of claim 1, wherein reconfiguring a TAG configuration comprises:
changing the specific TAG, if the specific TAG is part of a current TAG configuration of the user equipment.

6. A user equipment performing a Radio Resource Control (RRC) connection reconfiguration procedure in a multiple component carrier system, the user equipment comprising:
a receiver configured for receiving, from a base station, an RRC connection reconfiguration message used to reconfigure RRC configuration in the user equipment, wherein the RRC connection reconfiguration message comprises TAG configuration information used to add, change or remove a Timing Advance Group (TAG) comprising one or more serving cells that use an identical timing advance value and an identical timing reference, from among serving cells in which an uplink component carrier is configured, and the TAG configuration information comprises TAG index information and information on a Time Advance Timer (TAT) value corresponding to the TAG;
an RRC message processing unit configured for performing an RRC connection reconfiguration based on the RRC connection reconfiguration message; and
a transmitter for transmitting, to the base station, an RRC connection reconfiguration completion message indicating the completion of the RRC connection reconfiguration,
wherein the RRC message processing unit reconfigures a TAG configuration of the user equipment with a specific TAG indicated by the TAG index information, and applies the TAT value to the specific TAG.

7. The user equipment of claim 6, wherein the TAG configuration information is used to reconfigure a maximum of three secondary TAG (sTAG).

8. The user equipment of claim 6, wherein the RRC message processing unit reconfigures a TAG configuration of Medium Access Control (MAC) of the user equipment based on the TAG configuration information.

9. The user equipment of claim 6, wherein the RRC message processing unit adds the specific TAG, if the specific TAG is not part of a current TAG configuration of the user equipment.

10. The user equipment of claim 6, wherein the RRC message processing unit changes the specific TAG, if the specific TAG is part of a current TAG configuration of the user equipment.

11. A method of a base station performing a Radio Resource Control (RRC) connection reconfiguration procedure in a multiple component carrier system, the method comprising:
generating, an RRC connection reconfiguration message used to reconfigure RRC configuration in a user equipment, wherein the RRC connection reconfiguration message comprises TAG configuration information used to add, change or remove a Timing Advance Group (TAG) comprising one or more serving cells that use an identical timing advance value and an identical timing reference, from among serving cells in which an uplink component carrier is configured, and the TAG configuration information comprises TAG index information and information on a Time Advance Timer (TAT) value corresponding to the TAG;
transmitting the RRC connection reconfiguration message to the user equipment; and
receiving an RRC connection reconfiguration completion message, indicating the completion of the RRC connection reconfiguration, from the user equipment.

12. The method of claim 11, wherein the TAG configuration information is used to reconfigure a maximum of three secondary TAG (sTAG).

13. The method of claim 11, wherein the TAG configuration information is used to reconfigure TAG configuration of Medium Access Control (MAC) of the user equipment.

14. A base station performing a Radio Resource Control (RRC) connection reconfiguration procedure in a multiple component carrier system, the base station comprising:
a Timing Advance Group (TAG) processing unit configured to generate an RRC connection reconfiguration message used to reconfigure RRC configuration in a user equipment, wherein the RRC connection reconfiguration message comprises TAG configuration information used to add, change or remove a Timing Advance Group (TAG) comprising one or more serving cells that use an identical timing advance value and an identical timing reference, from among serving cells in which an uplink component carrier is configured, and the TAG configuration information comprises TAG index information and information on a Time Advance Timer (TAT) value corresponding to the TAG;
a transmitter configured to transmit the RRC connection reconfiguration message to the user equipment; and
a receiver configured to receive an RRC connection reconfiguration completion message, indicating the completion of the RRC connection reconfiguration from the user equipment.

15. The base station of claim 14, wherein the TAG processing unit generates the TAG configuration information in order to reconfigure a maximum of three secondary TAG (STAG).

16. The base station of claim 14, wherein the TAG processing unit generates the TAG configuration information in order to reconfigure a TAG configuration of Medium Access Control (MAC) of the user equipment.
